(19) United States
(12) Patent Application Publication
(10) Pub. No.: US 2021/0371667 A1
(43) Pub. Date: Dec. 2, 2021

(54) COMPOSITION INCLUDING AMINO-FUNCTIONAL SILANES AND METHOD OF APPLYING A SEALANT TO A SUBSTRATE

(71) Applicant: 3M INNOVATIVE PROPERTIES COMPANY, St. Paul, MN (US)

(72) Inventors: Susan E. DeMoss, Stillwater, MN (US); Erik M. Townsend, South Saint Paul, MN (US); Jonathan D. Zook, Stillwater, MN (US)

(21) Appl. No.: 17/277,104

(22) PCT Filed: Sep. 26, 2019
(86) PCT No.: PCT/IB2019/058193

§ 371 Date: Mar. 17, 2021

Related U.S. Application Data
(60) Provisional application No. 62/737,600, filed on Sep. 27, 2018.

(51) Int. Cl. C09D 4/00; C09D 5/22; C09D 5/32; C09D 183/08

(52) U.S. Cl. CPC C09D 4/00; C09D 183/08; C09D 5/32; C09D 5/22

(57) ABSTRACT

The composition includes a first amino-functional silane including an amino group and a silane group, in which the amino group and the silane group are connected by an organic linking group, and a second amino-functional silane including a secondary or tertiary amino group and least two independently selected silane groups, in which the secondary or tertiary amino group is connected to each of the two independently selected silane groups by organic linking groups. The first amino-functional silane can be a polyamino-functional silane having at least two amino groups and a silane group in which at least one of the amino groups and the silane group are connected by an organic linking group. The composition can include a photoluminescent compound exhibiting photoluminescence at an excitation wavelength above 400 nanometers. Use of the composition as an adhesion promoter and a method including applying the composition to a substrate surface are also disclosed.

### CROSS-REFERENCE TO RELATED APPLICATION

This application claims priority to U.S. Provisional Application No. 62/737,600, filed Sep. 27, 2018, the disclosure of which is incorporated by reference in its entirety herein.

### BACKGROUND

Sulfur-containing polymers are known to be well-suited for use in aerospace sealants due to their fuel-resistant nature upon crosslinking. Such crosslinking can be carried out, for example, by reaction of a thiol-terminated sulfur-containing compound with an epoxy resin, generally in the presence of an amine accelerator as described in U.S. Pat. No. 5,912,319 (Zook et al.). A desirable combination of properties for aerospace sealants, which is difficult to obtain, is the combination of long application time (i.e., the time during which the sealant remains usable) and short curing time (the time required to reach a predetermined strength).

Other crosslinked sulfur-containing polymers have been made, for example, by reaction of a thiol-terminated sulfur-containing compound with a polyene in the presence of a photoinitiator as described in U.S. Pat. Appl. Nos. 2012/0040103 (Keledjian et al.) and 2016/0032058 (Ye et al.).

However, adhesion of aerospace sealants to surfaces can be challenging. An aerospace sealant must meet the demanding performance requirements including adhesion following exposure to a wide range of solvents including aviation fuel, oil, salt, and water under severe thermal and environmental conditions. It is also desirable that an aerospace sealant meet these performance requirements when applied to a wide range of surfaces including aerospace-grade metals, composites, and coatings. Adhesion of aerospace sealant compositions can be improved by adding adhesion promoters to the composition as unreactive or reactive components or by pretreating a surface with a composition containing adhesion promoters. U.S. Pat. Appl. Pub. No. 2016/0257819 (Pathak et al.) describes compositions containing partially reacted silanes that can be used as primer coatings to improve the surface adhesion of aerospace sealants.

### SUMMARY

The present disclosure provides a composition useful, for example, for improving the adhesion between a substrate and a sealant. The composition can improve adhesion before and after immersing the sealant-coated substrate in a variety of fluids employed in the aerospace industry.

The demand for increased production rates has pushed sealant formulators to develop faster curing systems and even directed-energy, triggered, cure-on-demand sealants. When photochemically curing thiol-terminated sulfur-containing compounds to make sealants, it has been generally considered desirable to achieve full cure as quickly as possible (e.g., in minutes or even seconds). With the rapid gelling and curing of photochemically cured sealants, however, the mobility of small molecules within the sealant is inhibited, which can hinder the development of adequate adhesion between the sealant and the substrate. Unfortunately, when the user perceives that the sealant has reached an acceptable final state of curing, the sealant may not be adequately adhered to the substrate. Thus, the composition of the present disclosure may be particularly useful for improving adhesion between a photochemically cured sealant and a substrate.

In one aspect, the present disclosure provides a composition that includes a first amino-functional silane, a second amino-functional silane, and a photoluminescent compound exhibiting photoluminescence at an excitation wavelength above 400 nanometers. The first amino-functional silane has an amino group and a silane group, and the amino group and the silane group are connected by an organic linking group. The second amino-functional silane has a secondary or tertiary amino group and least two independently selected silane groups, and the secondary or tertiary amino group is connected to each of the two independently selected silane groups by organic linking groups. The composition may contain water, and, in some embodiments, organic solvent.

In another aspect, the present disclosure provides a composition that includes a polyamino-functional silane and a second amino-functional silane. The polyamino-functional silane includes at least two amino groups and a silane group, and at least one of the amino groups and the silane group are connected by an organic linking group. The second amino-functional silane includes a secondary or tertiary amino group and least two independently selected silane groups, and the secondary or tertiary amino group is connected to each of the two independently selected silane groups by organic linking groups. The composition may contain water, and, in some embodiments, organic solvent. The composition may also contain a photoluminescent compound exhibiting photoluminescence at an excitation wavelength above 400 nanometers.

In another aspect, the present disclosure provides the use of the composition described above or below in any of its embodiments as a primer for a sealant on an aircraft component.

In another aspect, the present disclosure provides an aircraft component primed with the composition described above or below in any of its embodiments.

In another aspect, the present disclosure provides a method of sealing a substrate. The method includes applying the composition described above or below to a surface of the substrate to provide a primed surface and subsequently applying a curable sealant composition. The sealant composition can include a polythiol.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility but may be swellable in the presence of an appropriate solvent.

The term “polymer or polymeric” will be understood to include polymers, copolymers (e.g., polymers formed using two or more different monomers), oligomers or monomers that can form polymers, and combinations thereof, as well as polymers, oligomers, monomers, or copolymers that can be blended.

“Alkyl group” and the prefix “alk-” are inclusive of both straight chain and branched chain groups and of cyclic groups. In some embodiments, alkyl groups have up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms. Terminal “alkenyl” groups have at least 3 carbon atoms.

“Alkylene” is the multivalent (e.g., divalent or trivalent) form of the “alkyl” groups defined above.

“Arylalkylene” refers to an “alkylene” moiety to which an aryl group is attached. “Alkylarylene” refers to an “arylene” moiety to which an alkyl group is attached.

The terms “aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, cyano, or nitro groups. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The phrase “interrupted by arylene”, for example, with regard to an alkylene group refers to having part of the alkylene on both sides of the arylene group. For example, —CH₂CH₂—C₆H₅—CH₂—CH₂— is an alkylene group interrupted by a phenylene group. Similarly, —CH₂CH₂—NH—CH₂—CH₂— is an alkylene group interrupted by an —NH— group.

An “adhesion promoter” may be included in a sealant composition or may be applied to a substrate before a sealant composition is applied to the substrate. An adhesion promoter applied to a substrate before a sealant composition is applied is also referred to as a “primer”.

All numerical ranges are inclusive of their endpoints and non-integral values between the endpoints unless otherwise stated (e.g., 1 to 5 includes 1, 1.5, 2, 2.75, 3, 3.80, 4, 5, etc.).

### DETAILED DESCRIPTION

Amino-functional silanes useful for practicing the present disclosure include at least one amino group and at least one silane group. The first amino-functional silane has an amino group and a silane group, and the amino group and the silane group are connected by an organic linking group. The second amino-functional silane has a secondary or tertiary amino group and least two independently selected silane groups, and the secondary or tertiary amino group is connected to each of the two independently selected silane groups by organic linking groups. The polyamino-functional silane includes at least two amino groups and a silane group, and at least one of the amino groups and the silane group are connected by an organic linking group. Silane groups useful in the compositions of the present disclosure include at least one hydrolyzable group. The term “hydrolyzable group” refers to a group which either is directly capable of undergoing condensation reactions under appropriate conditions or which is capable of hydrolyzing under appropriate conditions to yield a compound that is capable of undergoing condensation reactions. Appropriate conditions typically refer to the presence of water and optionally the presence of acid or base. Hydrolyzable groups include Y groups defined in formulas I, Ia, and II, below. Hydrolyzable groups (e.g., Y groups) are generally capable of hydrolyzing, for example, in the presence of water to produce silanol groups.

Silane groups useful in the compositions of the present disclosure can include one or two non-hydrolyzable groups. The term “non-hydrolyzable group” refers to a group generally not capable of hydrolyzing under the appropriate conditions described above for hydrolyzing hydrolyzable groups, (e.g., in water or acidic or basic aqueous conditions). Non-hydrolyzable groups include R² groups defined in formulas I, Ia, and II, below. In some embodiments, compositions of the present disclosure do not include non-hydrolyzable groups.

The first amino-functional silane useful for practicing the present disclosure can be represented by formula (I):

(R³)₂N—[R¹—Z]ₙ—R¹[Si(Y)ₚ(R²)₃₋ₚ] (I).

In formula I, —[R¹—Z]ₙ—R¹— represents the organic linking group. Each R¹ is independently alkylene, arylene, or alkylene optionally interrupted or terminated by arylene. In some embodiments, each R¹ is independently alkylene. In some embodiments, each R¹ is independently a divalent alkylene group having up to 6 (in some embodiments, 5, 4, or 3) carbon atoms. Each Z is independently —O— or —NR³—, and n is 0, 1, 2, or 3. In some embodiments, n is 0. In some embodiments, each Z is —NR³—. In some embodiments, n is 1, 2, or 3. In some embodiments, n is 1 or 2. In embodiments in which n is 1, 2, or 3, the first amino-functional silane includes diamino-functional silanes, triamino-functional silanes, and tetraamino-functional silanes, for example. In some embodiments in which n is greater than 0, —[R¹—Z]ₙ—R¹— is represented by formula —CH₂—CH₂—N(H)—CH₂—CH₂—CH₂— or —CH₂—CH₂—N(H)—CH₂—CH₂—N(H)—CH₂—CH₂—CH₂—.

In formula I, R² can be alkyl, aryl, or alkylenyl interrupted or terminated by aryl. In some embodiments, R² is alkyl or arylalkylenyl. In some of these embodiments, R² is alkyl (e.g., methyl or ethyl).

In formula I, each R³ is independently hydrogen, alkyl, aryl, or arylalkylenyl. In some embodiments, each R³ is hydrogen. In some embodiments, at least one R³ is alkyl having up to 6 (in some embodiments, up to 5, 4, 3, or 2) carbon atoms. In some embodiments, at least one R³ is methyl and at least one R³ is hydrogen.

In formula I, Y can be independently hydroxy, alkoxy, acetoxy, aryloxy, or halogen. In some embodiments, including any of the embodiments described above for R¹, R², or R³, Y is hydroxyl, methoxy, ethoxy, acetoxy, phenoxy, bromo, or chloro. In some embodiments, including any of the embodiments described above for R¹, R², or R³, Y² is methoxy, acetoxy, or chloro. Methoxy groups on a silane provide low steric hindrance and are readily hydrolyzed to effectively allow for formation of an —Si—O—Si— bond. Acetoxy and chloro groups on a silane are also readily hydrolyzed for at least the same reason and therefore are expected to be as effective or even more effective than methoxy groups in allowing formation of an —Si—O—Si— bond.

In formula I, p is 1, 2, or 3. In some embodiments, including any of the embodiments described above for R¹, R², R³, or Y, p is 3.

Examples of useful first amino-functional silanes include 3-aminopropyltrimethoxysilane, [3-(2-aminoethylamino)propyl]trimethoxysilane, 3-[2-(2-aminoethylamino)ethylaminolpropyltrimethoxysilane, and combinations thereof. In some embodiments, the first amino-functional silane is [3-(2-aminoethylamino)propyl]trimethoxysilane, 3-12-(2-aminoethylamino)ethylamino]propyltrimethoxysilane, or a combination thereof.

In some embodiments, the composition of the present disclosure includes a polyamino-functional silane represented by formula Ia:

(R⁹)₂N—[R⁷—N(H)]ₘ—R⁷—Si(Y)ₚ(R⁸)₃₋ₚ] Ia.

In some embodiments of the first amino-functional silane described above, the first amino-functional silane is the polyamino-functional silane represented by formula Ia. In formula Ia, —[R⁷—N(H)]ₘ—R⁷— represents the organic linking group. Each R⁷ is independently alkylene. In some embodiments, each R⁷ is independently a divalent alkylene group having up to 6 (in some embodiments, 5, 4, or 3) carbon atoms. In formula Ia, m is 1, 2, or 3. In some embodiments, m is 1 or 2. The polyamino-functional silane can be a diamino-functional silane, triamino-functional silane, tetraamino-functional silane, or a combination thereof, for example. In some embodiments, —[R⁷—N(H)]ₘ—R⁷— is represented by formula —CH₂—CH₂—N(H)—CH₂—CH₂—CH₂— or —CH₂—CH₂—N(H)—CH₂—CH₂—N(H)—CH₂—CH₂—CH₂—.

In formula Ia, R⁸ can be alkyl, aryl, or alkylenyl interrupted or terminated by aryl. In some embodiments, R⁸ is alkyl or arylalkylenyl. In some of these embodiments, R⁸ is alkyl (e.g., methyl or ethyl).

In formula Ia, each R⁹ is independently hydrogen, alkyl, aryl, or arylalkylenyl. In some embodiments, each R⁹ is hydrogen. In some embodiments, at least one R⁹ is alkyl having up to 6 (in some embodiments, up to 5, 4, 3, or 2) carbon atoms. In some embodiments, one R⁹ is methyl and one R⁹ is hydrogen.

Examples of useful polyamino-functional silanes include [3-(2-aminoethylamino)propyl]trimethoxysilane, 3-[2-(2-aminoethylamino)ethylamino]propyltrimethoxysilane, and combinations thereof.

The second amino-functional silane useful for practicing the present disclosure can be represented by formula II:

(R⁶)₂N₄[R⁴—Z′]ᵣ—R⁴—[Si(Y)ₚ(R⁵)₃₋ₚ] (II)

In formula II, —[R⁴—Z′]ᵣ—R⁴— represents the organic linking group. Each R⁴ is independently arylene or alkylene optionally interrupted or terminated by arylene. In some embodiments, each R⁴ is independently a divalent alkylene group. In some embodiments, each R⁴ is independently a divalent alkylene group having up to 6 (in some embodiments, 5, 4, or 3) carbon atoms. Each Z′ is independently —O— or —NR⁶—, and r is 0, 1, 2, or 3. In some embodiments, r is 0. In some embodiments, each Z is —NR⁶—. In some embodiments, r is 1, 2, or 3. In some embodiments, r is 1 or 2. In embodiments in which r is 1, 2, or 3, the second amino-functional silane includes diamino-functional silanes, triamino-functional silanes, and tetraamino-functional silanes, for example. In some embodiments in which r is greater than 0, —[R⁴—Z′]ᵣ—R⁴— is represented by formula —CH₂—CH₂—N(R⁶)—CH₂—CH₂—CH₂— or —CH₂—CH₂—N(R⁶)—CH₂—CH₂—N(R⁶)—CH₂—CH₂—CH₂—.

In formula II, each R⁵ can independently be alkyl, aryl, or alkylenyl interrupted or terminated by aryl. In some embodiments, R⁵ is alkyl or arylalkylenyl. In some of these embodiments, R⁵ is alkyl (e.g., methyl or ethyl).

In formula II, each R⁶ is independently hydrogen, alkyl, arylalkylenyl, or —R⁴—[Si(Y)ₚ(R⁵)₃₋ₚ], where R⁴ is defined as in any of the above embodiments. In some embodiments, at least one R⁶ group is hydrogen or alkyl, and at least one R⁶ group is —R⁴—[Si(Y)ₚ(R⁵)₃₋ₚ]. In some of these embodiments, at least one R⁶ group is alkyl, and at least one R⁶ group is —R⁴—[Si(Y)ₚ(R⁵)₃₋ₚ]. In some of these embodiments, alkyl may have up to 6 (in some embodiments, up to 5, 4, 3, or 2) carbon atoms. In some embodiments, at least one R⁶ group is hydrogen or methyl, and at least one R⁶ group is —R⁴—[Si(Y)ₚ(R⁵)₃₋ₚ]. In some of these embodiments, at least one R⁶ group is hydrogen, and at least one R⁶ group is —R⁴—[Si(Y)ₚ(R⁵)₃₋ₚ].

In formula II, Y and p are independently defined as above for formula I, in any of their embodiments. Also, R⁴ and R⁶ are selected such that at least two independently selected —Si(Y)ₚ(R⁵)₃₋ₚ groups are present in the compound represented by formula II.

Examples of second amino-functional silanes useful for practicing the present disclosure include bis(3-trimethoxysilylpropyl)amine, bis(3-triethoxysilylpropyl)amine, N-methyl-bis(3-trimethoxysilylpropyl)amine, N,N′-bis[3-trimethoxysilylpropyl]-ethylenediamine, N,N-bis[3-trimethoxysilylpropyl]-ethylenediamine, or a combination thereof. In some embodiments, the second amino-functional silane is N,N′-bis[3-trimethoxysilylpropyl]-ethylenediamine, N,N-bis[3-trimethoxysilylpropyl]-ethylenediamine, or a combination thereof.

The molar ratio of the first amino-functional silane (in some embodiments, the polyamino-functional silane) to the second amino-functional silane (in some embodiments, the second amino-functional silane) can be in a range from 10:1 to 1:10, 9:1 to 1:9, 5:1 to 1:5, 2:1 to 1:2, or 1.5:1 to 1:1.5. In some embodiments, the first amino-functional silane (in some embodiments, the polyamino-functional silane) and the second amino-functional silane (in some embodiments, the second amino-functional silane) combined are present in the composition in a range from 0.01 percent to 15 percent (in some embodiments, 0.05 to 10, 0.1 to 10, or 1 to 10 percent) by weight, based on the total weight of the composition.

In some embodiments, the first amino-functional silane (in some embodiments, the polyamino-functional silane) and the second amino-functional silane (in some embodiments, the second polyamino-functional silane) together make up at least 70, 75, 80, 85, 90, or 95 percent by weight of silane compounds in the composition. In some embodiments, no silane compound other than the first amino-functional silane (in some embodiments, the polyamino-functional silane) and the second amino-functional silane are present in the composition. In some embodiments, the composition is substantially free of mercaptosilanes. “Substantially free of mercaptosilanes” includes being free of mercaptosilanes and includes having up to 2, 1, 0.5, 0.25, 0.1, or 0.01 weight percent mercaptosilanes, based on total weight of silanes in the composition. In some embodiments, the composition is substantially free of organo-functional silanes that are reactive with thiol groups. Organo-functional silanes that are reactive with thiol groups include alkenyl, acrylate, methacrylate, or epoxy-functional silanes. “Substantially free of organo-functional silanes that are reactive with thiol groups” includes being free of such organo-functional silanes and includes having up to 2, 1, 0.5, 0.25, 0.1, or 0.01 weight percent organo-functional silanes that are reactive with thiol groups, based on total weight of silanes in the composition.

In some embodiments, the first amino-functional silane (in some embodiments, the polyamino-functional silane) and the second amino-functional silane (in some embodiments, the second polyamino-functional silane) together make up at least 70, 75, 80, 85, 90, or 95 percent by weight of solids in the composition. “Solids” refer to components in the composition excluding any organic solvent and water that may be present. In some embodiments, the composition is substantially free of adhesion promoters other than silanes (e.g., titanates or zirconates). “Substantially free of titanates and zirconates” includes being free of titanates and zirconates and includes having up to 2, 1, 0.5, 0.25, 0.1, or 0.01 weight percent titanates and zirconate, based on total weight of solids in the composition.

Compositions according to the present disclosure are useful, for example, as adhesion promoters that may be applied as primers on components of buildings, windows, automobiles, aircraft, marine vessels, and other transportation vessels to improve the adhesion of a sealant to the structure. Commercially available adhesion promoters are typically clear or contain simple dyes meant to aid with visual inspection of promoted surfaces. The clear adhesion promoters rely on the technician's skill and experience for reliable application while the dyed promoters require bright light and unimpeded visual access for proper inspection. Complex part configurations, low-light conditions, and confined-space-areas encountered in aircraft manufacture and the manufacture of other transportation vessels would benefit from a robust method of inspection. We have found that including a photoluminescent compound in the composition of the present disclosure provides a means to rapidly and reliably verify complete coverage.

Accordingly, in some embodiments, compositions of the present disclosure include a photoluminescent compound. The choice of photoluminescent compounds includes a wide range of materials. Desirably, the photoluminescent compound exhibits photoluminescence at an excitation wavelength above 400 nanometers. Useful photoluminescent compounds include those that fluoresce. In selecting a photoluminescent compound, it can be advantageous to select a compound that does not significantly photobleach under the conditions of inspection. Examples of useful photoluminescent compounds for the compositions of the present disclosure include [9-(2-carboxyphenyl)-6-diethylamino-3-xanthenylidene]-diethylammonium chloride (Rhodamine B), 9-[2-(ethoxycarbonyl)phenyl]-3,6-bis(ethylamino)-2,7-dimethylxanthylium chloride (1:1) (Rhodamine G), 6-amino-9-(2-methoxycarbonylphenyl)xanthen-3-ylidene]azanium chloride (Rhodamine 123) and 3′,6′-dihydroxyspiro[isobenzofuran-1(3H),9′-[9H]xanthen]-3-one (Fluorescein). In some embodiments, the photoluminescent compound is [9-(2-carboxyphenyl)-6-diethylamino-3-xanthenylidene]-diethylammonium chloride (Rhodamine B).

The photoluminescent compound can be included in the composition of the present disclosure in any useful amount. In some embodiments, the photoluminescent compound is included in the composition in an amount up to 5, 4, 3, 2, 1.5, 1, or 0.5 percent by weight, based on the total weight of solids (that is, excluding any organic solvent or water) in the composition. In some embodiments, the photoluminescent compound is included in the composition in an amount of at least 0.05, 0.1, or 0.25 percent by weight, based on the total weight of solids in the composition.

In the method of sealing a substrate according to the present disclosure, the presence of the photoluminescent compound facilitates the inspection of the primed surface before applying the curable sealant composition. In some embodiments, the method of sealing a substrate includes inspecting the primed surface by exposing the primed surface to blue light before applying the curable sealant composition.

In some embodiments, the composition of the present disclosure includes water. The amount of water can be selected such that the weight percent of water in the composition is greater than or equal to the weight percent of first and second amino-functional silanes in the composition. In some embodiments, the water is present in the composition in a range from 0.01 percent to 15 percent (in some embodiments, 0.05 to 10, 0.1 to 10, or 1 to 10 percent) by weight, based on the total weight of the composition. Water may be added to the composition separately or may be added as part of an aqueous acidic solution (e.g., concentrated hydrochloric acid is 37% by weight of the acid in water). In some cases, the water necessary for hydrolysis may be added to the primer composition, may be adventitious water in the solvent or adsorbed to the surface of the substrate, or may be present in the atmosphere to which the secondary or tertiary amino-functional compound is exposed (e.g., an atmosphere having a relative humidity of at least 10%, 20%, 30%, 40%, or even at least 50%). For water-based adhesion promoters, the water may be present in the composition in an amount of at least 50, 60, or 70 percent by weight, based on the total weight of the composition and may be present in an amount up to 85, 90, 95 percent by weight or more, based on the total weight of the composition.

Typically, treatment compositions useful in practicing the present disclosure include organic solvent. As used herein, the term “organic solvent” includes a single organic solvent and a mixture of two or more organic solvents. Useful organic solvents are typically capable of dissolving at least about 0.01 (e.g., 0.1) percent by weight of amino-functional silanes represented by formula I, Ia, or II in the presence of at least 0.01 percent by weight water.

Suitable organic solvents include aliphatic alcohols (e.g., methanol, ethanol, and isopropanol); ketones (e.g., acetone, 2-butanone, and 2-methyl-4-pentanone); esters (e.g., ethyl acetate, butyl acetate, and methyl formate); ethers (e.g., diethyl ether, diisopropyl ether, methyl t-butyl ether, 2-methoxypropanol, and dipropyleneglycol monomethylether (DPM)); and hydrocarbons such as alkanes (e.g., heptane, decane, and paraffinic solvents). In some embodiments, the organic solvent is methanol, ethanol, isopropanol, or a mixture thereof. In some embodiments, the organic solvent is ethanol. Although organic solvent is not required for the composition of the present disclosure, in some embodiments, solvent is present in an amount of at least 50, 60, or 70 percent by weight, based on the total weight of the composition and may be present in an amount up to 95, 90, or 85 percent by weight, based on the total weight of the composition. The amounts of the organic solvent, first and second amino-functional silanes, water, and any other components may be chosen to provide a homogeneous composition.

In some embodiments, the composition of the present disclosure comprise acid. Acid can be useful, for example, for effecting the hydrolysis of silane groups at a lower temperature or at a faster rate than in the absence of acid. In some embodiments, the acid comprises at least one of (i.e., comprises one or more of) acetic acid, citric acid, formic acid, triflic acid, perfluorobutyric acid, sulfuric acid, or hydrochloric acid. In some embodiments, the acid is hydrochloric acid or acetic acid. Stronger acids typically effect the hydrolysis of silane groups at a lower temperature than weaker acids and are therefore sometimes desirable. The acid may be present in the composition in a range, for example, from about 0.004, 0.007, 0.01, or 0.015 percent by weight to about 1, 1.5, 2, 2.5, or 3 percent by weight, based on the total weight of the composition. In some embodiments, the acid is present in an amount up to 0.5, 0.4, 0.3, 0.2, or 0.1 percent by weight based on the total weight of the composition.

The method of the present disclosure includes applying the composition described above in any of its embodiments to a surface of a substrate to provide a primed surface and subsequently applying a curable sealant composition on the primed surface. The present disclosure also provides use of the composition described above in any of its embodiments as an adhesion promoter for a sealant on surface (e.g., on an aircraft component).

Surfaces to which sealants may be applied may include metals such as titanium, stainless steel, and aluminum, and/or composites, any of which may be anodized, primed, organic-coated (e.g., polymer-coated), or chromate-coated.

Curable sealants in the method according to the present disclosure can be cured into, for example, aviation fuel-resistant sealants. Aviation fuel-resistant sealants are widely used by the aircraft industry for many purposes. Commercial and military aircraft are typically built by connecting a number of structural members, such as longitudinal stringers and circular frames. The aircraft skin, whether metal or composite, is attached to the outside of the stringers using a variety of fasteners and adhesives. These structures often include gaps along the seams, joints between the rigidly interconnected components, and overlapping portions of the exterior aircraft skin. The method according to the present disclosure can be useful, for example, for sealing such seams, joints, and overlapping portions of the aircraft skin. The curable sealant may be applied, for example, to aircraft fasteners, windows, access panels, and fuselage protrusions. The sealant disclosed herein may prevent the ingress of weather and may provide a smooth transition between the outer surfaces to achieve desired aerodynamic properties. The method according to the present disclosure may likewise be carried out on interior assembles to prevent corrosion, to contain the various fluids and fuels necessary to the operation of an aircraft, and to allow the interior of the aircraft (e.g., the passenger cabin) to maintain pressurization at higher altitudes. Among these uses are the sealing of integral fuel tanks and cavities.

Sealants may optionally be used in combination with a seal cap, for example, over rivets, bolts, or other types of fasteners. A seal cap may be made using a seal cap mold, filled with a curable sealant, and placed over a fastener. The curable sealant may then be cured. In some embodiments, the seal cap and the curable sealant may be made from the same material. For more details regarding seal caps, see, for example, Int. Pat. App. Pub. No. WO2014/172305 (Zook et al.).

A composition of the present disclosure may be applied to a surface of a substrate either shortly after its preparation (e.g., up to one hour), or after a period of time (e.g., more than 1 hour, 3 to 8 hours, 24 hours, 48 hours, several days, several weeks, or several months). Hydrolysis and condensation of the silanes may be more likely to occur after compositions are exposed to time and temperature.

Before being applied to a surface of a substrate, the composition of the present disclosure may be prepared from a concentrate (e.g., a concentrated solution of the first and second amino-functional silanes represented by formula I, Ia, or II, optionally in water and/or organic solvent. The concentrate may be stable for several weeks (e.g., at least one, two, or three months) and may comprise the first and second amino-functional silanes in an amount of at least 10, 20, 25, 30, or at least 40 percent by weight, based on the total weight of the concentrate. Concentrates may be diluted shortly before use, for example, with water, organic solvent, and optionally other components.

In some embodiments, the surface of the substrate may be cleaned before applying the composition of the present disclosure. It is typically desirable to remove foreign materials such as dust, oil, grease, and other contaminants. Cleaning may be carried out, for example, with an organic solvent (e.g., a ketone such as acetone or an alcohol such as isopropanol), with water, with a solution of sodium hydroxide (e.g., 2, 5, or 10 percent by weight aqueous sodium hydroxide), or with a combination thereof. The cleaning may be carried out at room temperature or at an elevated temperature (e.g., in a range from about 50° C. to about 100° C.). Techniques for cleaning a metal surface include wiping, rinsing, and sonicating. After cleaning, the metal surface of the substrate may be dried, for example, under a stream of air or nitrogen or at an elevated temperature. In some embodiments, the surface of the substrate may be cleaned with the composition of the present disclosure.

A wide variety of methods can be used to apply the composition of the present disclosure (e.g., brushing, spraying, dipping, rolling, spreading, or chemical vapor deposition). A surface of a substrate can typically be treated with the composition at room temperature (typically, about 15° C. to about 30° C. or about 20° C. to about 25° C.). Or the composition can be applied to surfaces that are preheated (e.g., at a temperature of 60° C. to 150° C.). Following application, the primed surface can be dried and cured at ambient or elevated temperature (e.g., at 40° C. to 300° C., 50° C. to 150° C., or 75° C. to 140° C.) and for a time sufficient to dry. In some embodiments, excellent adhesion between the sealant and the substrate can be obtained upon applying the composition of the present disclosure to the surface of the substrate and drying at ambient temperature. Dried substrates typically no longer have organic solvent or water present on the surface. In some embodiments, applying the curable sealant composition takes place within 6 hours, 4 hours, or 2 hours after applying the composition to provide the primed surface.

Sulfur-containing polymers are known to be well-suited for use in aerospace sealants due to their fuel-resistant nature upon crosslinking. Accordingly, in some embodiments, the curable sealant composition includes a polythiol having more than one thiol group. In some embodiments, the polythiol includes at least two thiol groups. Generally, in order to achieve chemical crosslinking between polymer chains, greater than two thiol groups and/or greater than two crosslinking groups are present in at least some of the polythiol and curing agent molecules, respectively. In some embodiments, mixtures of curing agents and/or polythiols having at least 5 percent functional equivalents of thiol groups contributed by polythiols having at least three thiol groups may be useful.

A variety of polythiols having more than one thiol group are useful in the method according to the present disclosure. In some embodiments, the polythiol is monomeric. In these embodiments, the polythiol may be an alkylene, arylene, alkylarylene, arylalkylene, or alkylenearylalkylene having at least two mercaptan groups, wherein any of the alkylene, alkylarylene, arylalkylene, or alkylenearylalkylene is optionally interrupted by one or more ether (i.e., —O—), thioether (i.e., —S—), or amine (i.e., —NR¹—) groups and optionally substituted by alkoxy or hydroxyl. Useful monomeric polythiols may be dithiols or polythiols with more than 2 (in some embodiments, at least 3 or 4) mercaptan groups. In some embodiments, the polythiol is an alkylene dithiol in which the alkylene is optionally interrupted by one or more ether (i.e., —O—) or thioether (i.e., —S—) groups. Examples of useful dithiols include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 1,5-dimercapto-3-oxapentane and mixtures thereof. Examples of polythiols having more than two mercaptan groups include propane-1,2,3-trithiol; 1,2-bis[(2-mercaptoethyl)thio]-3-mercaptopropane; tetrakis(7-mercapto-2,5-dithiaheptyl)methane; and trithiocyanuric acid. Combination of any of these or with any of the dithiols mentioned above may be useful.

In some embodiments, the polythiol in the method according to the present disclosure is oligomeric or polymeric. Examples of useful oligomeric or polymeric polythiols include polythioethers and polysulfides. Polythioethers include thioether linkages (i.e., —S—) in their backbone structures. Polysulfides include disulfide linkages (i.e., —S—S—) in their backbone structures.

Polythioethers can be prepared, for example, by reacting dithiols with dienes, diynes, divinyl ethers, diallyl ethers, ene-ynes, or combinations of these under free-radical conditions. Useful dithiols include any of the dithiols listed above. Examples of suitable divinyl ethers include divinyl ether, ethylene glycol divinyl ether, butanediol divinyl ether, hexanediol divinyl ether, diethylene glycol divinyl ether, triethylene glycol divinyl ether, tetraethylene glycol divinyl ether, cyclohexanedimethanol divinyl ether, polytetrahydrofuryl divinyl ether, and combinations of any of these. Useful divinyl ethers of formula CH₂═CH—O—(—R^{2′}—O—)_{m′}—CH═CH₂, in which m′ is a number from 0 to 10, R^{2′} is C₂ to C₆ branched alkylene can be prepared by reacting a polyhydroxy compound with acetylene. Examples of compounds of this type include compounds in which R^{2′} is an alkyl-substituted methylene group such as —CH(CH₃)— (e.g., those obtained from BASF, Florham Park, N.J, under the trade designation “PLURIOL”, for which R² is ethylene and m is 3.8) or an alkyl-substituted ethylene (e.g., —CH₂CH(CH₃)— such as those obtained from International Specialty Products of Wayne, N.J., under the trade designation “DPE” (e.g., “DPE-2” and “DPE-3”). Examples of other suitable dienes, diynes, and diallyl ethers include 4-vinyl-1-cyclohexene, 1,5-cyclooctadiene, 1,6-heptadiyne, 1,7-octadiyne, and diallyl phthalate. Small amounts of trifunctional compounds (e.g., triallyl-1,3,5-triazine-2,4,6-trione, 2,4,6-triallyloxy-1,3,5-triazine) may also be useful in the preparation of oligomers.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.). In some embodiments, the polythioether is represented by formula HS—R^{3′}—[S—(CH₂)₂—O—[—R^{4′}—O—]_{m′}—(CH₂)₂—S—R^{3′}—]_{n′}—SH, wherein each R^{3′} and R^{4′} is independently a C₂₋₆ alkylene, wherein alkylene may be straight-chain or branched, C₆₋₈ cycloalkylene, C₆₋₁₀ alkylcycloalkylene, —[(CH₂—)_{p′}—X—]_{q}—(—CH₂—)_{r′}, in which at least one —CH₂— is optionally substituted with a methyl group, X is selected from the group consisting of O, S and —NR^{5′}—, R^{5′} denotes hydrogen or methyl, m′ is a number from 0 to 10, n′ is a number from 1 to 60, p′ is an integer from 2 to 6, q is an integer from 1 to 5, and r is an integer from 2 to 10. Polythioethers with more than two mercaptan groups may also be useful.

In some embodiments, a free-radical initiator is combined with the dithiols with dienes, diynes, divinyl ethers, diallyl ethers, ene-ynes, or combinations of these, and the resulting mixture is heated to provide the polythioethers. Examples of suitable free-radical initiators include azo compounds (e.g., 2,2′-azobisisobutyronitrile (AIBN), 2,2′-azobis(2-methylbutyronitrile), or azo-2-cyanovaleric acid). In some embodiments, the free-radical initiator is an organic peroxide. Examples of useful organic peroxides include hydroperoxides (e.g., cumene, tert-butyl or tert-amyl hydroperoxide), dialkyl peroxides (e.g., di-tert-butylperoxide, dicumylperoxide, or cyclohexyl peroxide), peroxyesters (e.g., tert-butyl perbenzoate, tert-butyl peroxy-2-ethylhexanoate, tert-butyl peroxy-3,5,5-trimethylhexanoate, tert-butyl monoperoxymaleate, or di-tert-butyl peroxyphthalate), peroxycarbonates (e.g., tert-butylperoxy 2-ethylhexylcarbonate, tert-butylperoxy isopropyl carbonate, or di(4-tert-butylcyclohexyl) peroxydicarbonate), ketone peroxides (e.g., methyl ethyl ketone peroxide, 1,1-di(tert-butylperoxy)cyclohexane, 1,1-di(tert-butylperoxy)-3,3,5-trimethylcyclohexane, and cyclohexanone peroxide), and diacylperoxides (e.g., benzoyl peroxide or lauryl peroxide). The organic peroxide may be selected, for example, based on the temperature desired for use of the organic peroxide and compatibility with the monomers. Combinations of two or more organic peroxides may also be useful.

The free-radical initiator useful for making a polythioether may also be a photoinitiator.

Examples of useful photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); 1-hydroxycyclohexyl phenyl ketone; and acylphosphine oxide derivatives and acylphosphonate derivatives (e.g., bis(2,4,6-trimethylbenzoyl)phenylphosphine oxide, diphenyl-2,4,6-trimethylbenzoylphosphine oxide, isopropoxyphenyl-2,4,6-trimethylbenzoylphosphine oxide, or dimethyl pivaloylphosphonate). Many photoinitiators are available, for example, from IGM Resins under the trade designation “OMNIRAD”. The photoinitiator may be selected, for example, based on the desired wavelength for curing and compatibility with the monomers. When using a photoinitiator, the polythioether is typically prepared using an actinic light source (e.g., at least one of a blue light source or a UV light source).

Polythioethers can also be prepared, for example, by reacting dithiols with diepoxides, which may be carried out by stirring at room temperature, optionally in the presence of a tertiary amine catalyst (e.g., 1,4-diazabicyclo[2.2.2]octane (DABCO)). Useful dithiols include any of those described above. Useful epoxides can be any of those having two epoxide groups. In some embodiments, the diepoxide is a bisphenol diglycidyl ether, wherein the bisphenol (i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Polythioethers prepared from dithiols and diepoxides have pendent hydroxyl groups and can have structural repeating units represented by formula —S—R^{3′}—S—CH₂—CH(OH)—CH₂—O—C₆H₅—CH₂—C₆H₅—O—CH₂—CH(OH)—CH₂—S—R^{3′}—S—, wherein R^{3′} is as defined above, and the bisphenol (i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Mercaptan terminated polythioethers of this type can also be reacted with any of the dienes, diynes, divinyl ethers, diallyl ethers, and ene-ynes listed above under free radical conditions. Any of the free-radical initiators and methods described above may be useful for preparing the polythioethers. In some embodiments, the thermal initiators described above are used, and the resulting mixture is heated to provide the polythioethers.

Other useful polythiols can be formed from the addition of hydrogen sulfide (H₂S) (or its equivalent) across carbon-carbon double bonds. For example, dipentene and triglycerides which have been reacted with H₂S (or its equivalent). Specific examples include dipentene dimercaptan and those polythiols available as POLYMERCAPTAN 358 (mercaptanized soybean oil) and POLYMERCAPTAN 805C (mercaptanized castor oil) from Chevron Phillips Chemical Co. LLP. At least for some applications, the polythiols are POLYMERCAPTAN 358 and 805C since they are produced from largely renewable materials, i.e., the triglycerides, soybean oil and castor oil, and have relatively low odor in comparison to many thiols. Useful triglycerides have at least 2 sites of unsaturation, i.e., carbon-carbon double bonds, per molecule on average, and sufficient sites are converted to result in at least 2 thiols per molecule on average. In the case of soybean oil, this requires a conversion of approximately 42 percent or greater of the carbon-carbon double bonds, and in the case of castor oil this requires a conversion of approximately 66 percent or greater of the carbon-carbon double bonds. Typically, POLYMERCAPTAN 358 and 805C can be obtained with conversions greater than approximately 60 percent and 95 percent, respectively. Useful polythiols of this type also include those derived from the reaction of H₂S (or its equivalent) with the glycidyl ethers of bisphenol A epoxy resins, bisphenol F epoxy resins, and novolak epoxy resins. A polythiol of this type is QX11, derived from bisphenol A epoxy resin, from Japan Epoxy Resins (JER) as EPOMATE. Other polythiols suitable include those available as EPOMATE QX10 and EPOMATE QX20 from JER.

Polysulfides are typically prepared by the condensation of sodium polysulfide with bis-(2-chloroethyl) formal, which provides linear polysulfides having two terminal mercaptan groups. Branched polysulfides having three or more mercaptan groups can be prepared using trichloropropane in the reaction mixture. Examples of useful polysulfides are described, for example, in 2,466,963 (Patrick et al); U.S. Pat. No. 2,789,958 (Fettes et al); U.S. Pat. No. 4,165,425 (Bertozzi); and U.S. Pat. No. 5,610,243 (Vieth et al.). Polysulfides are commercially available under the trademarks “THIOKOL” and “LP” from Toray Fine Chemicals Co., Ltd., Urayasu, Japan and are exemplified by grades “LP-2”, “LP-2C” (branched), “LP-3”, “LP-33”, and “LP-541”.

Polythioethers and polysulfides can have a variety of useful molecular weights. In some embodiments, the polythioethers and polysulfides have number average molecular weights in a range from 500 grams per mole to 20,000 grams per mole, 1,000 grams per mole to 10,000 grams per mole, or 2,000 grams per mole to 5,000 grams per mole.

In some embodiments, the curable sealant comprises at least one unsaturated compound comprising more than one carbon-carbon double bond, at least one carbon-carbon triple bond, or a combination thereof. These unsaturated compounds are useful, for example, as curing agents for polythiols. In some embodiments, the unsaturated compound includes at least two carbon-carbon double bonds, at least one carbon-carbon triple bond, or combinations thereof. Generally, in order to achieve chemical crosslinking between polymer chains, greater than two thiol groups and/or greater than two carbon-carbon double bonds, carbon-carbon triple bonds, or a combination thereof are present in at least some of the polythiol and unsaturated compounds, respectively. It should be understood that the unsaturated compound has carbon-carbon double bonds and/or carbon-carbon triple bonds that are reactive and generally not part of an aromatic ring. In some of these embodiments, the carbon-carbon double and triple bonds are terminal groups in a linear aliphatic compound. However, styryl groups and allyl-substituted aromatic rings may be useful. The unsaturated compound may also include one or more ether (i.e., —O—), thioether (i.e., —S—), amine (i.e., —NR¹—), or ester (e.g., so that the compound is an acrylate or methacrylate) groups and one or more alkoxy or hydroxyl substituents. In some embodiments, the unsaturated compound does not include ester groups or carbonate groups. In these embodiments, the unsaturated compound is not an acrylate, methacrylate, vinyl ester, or vinyl carbonate. Unsaturated compounds without ester and carbonate groups may be more chemically stable than unsaturated compounds that contain these groups. Suitable unsaturated compounds include dienes, diynes, divinyl ethers, diallyl ethers, ene-ynes, and trifunctional versions of any of these. Combinations of any of these groups may also be useful. Examples of useful unsaturated compounds having more than one carbon-carbon double bond and/or carbon-carbon triple bond include any of those described above in connection with the preparation of polythioethers. When curing polythiols having two thiol groups, a mixture of unsaturated compounds may be useful in which at least one unsaturated compound has two carbon-carbon double or triple bonds, and at least one unsaturated compound has at least three carbon-carbon double or triple bonds. Mixtures of unsaturated compounds having at least 5 percent functional equivalents of carbon-carbon double or triple bonds contributed by polyenes having at least three carbon-carbon double or triple bonds may be useful.

Further examples of unsaturated compounds suitable for curing polythiols include unsaturated hydrocarbon compounds having from 5 to 30 carbon atoms or 5 to 18 carbon atoms (e.g., 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,13-tetradecadiene, 1,15-hexadecadiene, 1,17-octadecadiene, 1,19-icosadiene, 1,21-docosadiene, divinylbenzene, dicyclopentadiene, limonene, diallylbenzene, triallylbenzene); vinyl or allyl ethers having from 4 to 30 carbon atoms or 4 to 18 carbon atoms (e.g., divinyl ether, ethylene glycol divinyl ether, 1,4-butanediol divinyl ether, 1,6-hexanediol divinyl ether, diethylene glycol divinyl ether, triethylene glycol divinyl ether, tetraethylene glycol divinyl ether, cyclohexanedimethanol divinyl ether, trimethylolpropane trivinyl ether, pentaerythritol tetravinyl ether, bisphenol A divinyl ether, bisphenol F divinyl ether, bisphenol A diallyl ether, and bisphenol F diallyl ether); diynes having from 5 to 30 carbon atoms or 5 to 15 carbon atoms (e.g., 1,6-heptadiyne); isocyanurates having from 9 to 30 carbon atoms or 9 to 15 carbon atoms (e.g., diallyl isocyanurate and triallyl isocyanurate); cyanurates having from 9 to 30 carbon atoms or 9 to 15 carbon atoms (e.g., diallyl cyanurate and triallyl cyanurate); and certain ethenyl and/or ethynyl-substituted polymers such as, for example, polytetrahydrofuryl divinyl ether, polyethylene oxide divinyl ether, polyethylene oxide diallyl ether, polypropylene oxide divinyl ether, polypropylene oxide diallyl ether, and mixtures thereof. Ethenyl and/or ethynyl-substituted polymers may have two, three, four, or more ethenyl (e.g., vinyl) and/or ethynyl (e.g., acetylenyl) pendant group and/or end groups. Compounds having both ethenyl and ethynyl groups may also be useful. Combinations of the foregoing may be useful.

Typically, the amounts of the polythiol(s) and unsaturated compound(s) are selected for the composition so that there is a stoichiometric equivalence of thiol groups and carbon-carbon double bonds, carbon-carbon triple bonds, or a combination thereof. In some embodiments, the number of the thiol groups is within 10, 5, 3, 2, of 1 percent of the number of the carbon-carbon double bonds. The stoichiometry expressed as a ratio of thiol groups to carbon-carbon double bonds can be in the range of 0.8 to 1.2, 0.9 to 1.1, or 0.95 to 1.05, although this is nota requirement.

In some embodiments, curable sealants useful for practicing the present disclosure include a Michael acceptor comprising more than one Michael acceptor group. A “Michael acceptor” refers to an unsaturated compound useful, for example, for curing polythiols, that is an activated alkene, such as an alkenyl group proximate to an electron-withdrawing group such as a ketone, halo, nitrile, carbonyl, or nitro group. Michael acceptors are well known in the art. A “Michael acceptor group” refers to an activated alkenyl group and an electron-withdrawing group. In some embodiments, a Michael acceptor comprises at least one of a vinyl ketone, a vinyl sulfone, a quinone, an enamine, a ketimine, oxazolidine, an acrylate, acrylonitrile, acrylamides, maleimides, alkyl methacrylates, cyanoacrylate, alpha, beta-unsaturated aldehydes, vinyl phosphonates, vinyl pyridines, beta-keto acetylenes, and acetylene esters. In some embodiments, the composition is substantially free of a Michael acceptor. “Substantially free” refers to having up to 5, 4, 3, 2, or 1 percent by weight of a Michael acceptor, based on the total weight of the composition. “Substantially free” of a Michael acceptor also includes being free of a Michael acceptor.

In some of these embodiments, including any of the embodiments described above in which the curable sealant includes a polythiol and an unsaturated compound, the curable sealant includes a photoinitiator. Photoinitiators suitable for curing a polythiol with a curing agent comprising an unsaturated compound having at least one carbon-carbon double bond and/or carbon-carbon triple bond include a free-radical photoinitiator. In some embodiments, the free radical photoinitiator is a cleavage-type photoinitiator. Cleavage-type photoinitiators include acetophenones, alpha-aminoalkylphenones, benzoin ethers, benzoyl oximes, acylphosphine oxides and bisacylphosphine oxides and mixtures thereof. Examples of useful photoinitiators include benzoin ethers (e.g., benzoin methyl ether or benzoin butyl ether); substituted acetophenone (e.g., 2,2-dimethoxy-2-phenylacetophenone or 2,2-diethoxyacetophenone); 1-hydroxycyclohexyl phenyl ketone; and acylphosphonate derivatives (e.g., bis(2,4,6-trimethylbenzoyl)phenylphosphine oxide, diphenyl-2,4,6-trimethylbenzoylphosphine oxide, isopropoxyphenyl-2,4,6-trimethylbenzoylphosphine oxide, or dimethyl pivaloylphosphonate). Other useful photoinitiators include those described above in connection with the preparation of polythioethers. Many photoinitiators are available, for example, from IGM Resins under the trade designation “OMNIRAD”. The photoinitiator may be selected, for example, based on the desired wavelength for curing and compatibility with the curable sealant. Two or more of any of these photoinitiators may also be used together in any combination.

A curable sealant including a photoinitiator can be packaged as a one-part product including the photoinitiator, or a two-part product in which at least one of the parts includes the photoinitiator and can be mixed just before it is applied to surface of the aircraft component. The photoinitiator can be added to the curable sealant in any amount suitable to initiate curing. In some embodiments, the photoinitiator is present in an amount in a range from 0.05 weight percent to about 5 weight percent (in some embodiments, 0.1 weight percent to 2.5 weight percent, or 0.1 weight percent to 2 weight percent), based on the total weight of the curable sealant.

In embodiments of the method of the present disclosure in which the curable sealant composition includes a photoinitiator, the method can further include exposing the curable sealant composition to actinic radiation to cure the curable sealant composition. Exposing the curable sealant composition to actinic radiation can be carried out using the methods described below, for example. Curing the curable sealant composition in this manner can be quite rapid, and the rapidity of these reactions results in swift gelling. Once gelation occurs, however, the mobility of small molecules within the sealant is inhibited, which can hinder the development of adequate adhesion between the sealant and the substrate. Therefore, the compositions of the present disclosure including a first amino-functional silane (in some embodiments, a polyamino-functional silane) and a second amino-functional silane may be particularly advantageous when the curable sealant composition includes a photoinitiator and/or when the method includes exposing the curable sealant composition to actinic radiation.

In some embodiments, the curable sealant composition further includes an organic peroxide. Examples of useful organic peroxides include hydroperoxides (e.g., cumene, tent-butyl or tent-amyl hydroperoxide), dialkyl peroxides (e.g., di-tert-butylperoxide, dicumylperoxide, or cyclohexyl peroxide), peroxyesters (e.g., tert-butyl perbenzoate, tent-butyl peroxy-2-ethylhexanoate, tert-butyl peroxy-3,5,5-trimethylhexanoate, tert-butyl monoperoxymaleate, or di-tent-butyl peroxyphthalate), peroxycarbonates (e.g., tert-butylperoxy 2-ethylhexylcarbonate, tert-butylperoxy isopropyl carbonate, or di(4-tert-butylcyclohexyl) peroxydicarbonate), ketone peroxides (e.g., methyl ethyl ketone peroxide, 1,1-di(tert-butylperoxy)cyclohexane, 1,1-di(tert-butylperoxy)-3,3,5-trimethylcyclohexane, and cyclohexanone peroxide), and diacylperoxides (e.g., benzoyl peroxide or lauryl peroxide). In some embodiments, the peroxide is selected from the group consisting of di-tert-butyl peroxide, methyl ethyl ketone peroxide, and benzoyl peroxide. The organic peroxide may be selected, for example, based on the temperature desired for use of the organic peroxide and compatibility with the polythiol and the unsaturated compound. Combinations of two or more organic peroxides may also be useful.

Organic peroxides can be useful, for example, as a free-radical initiator for curing the curable sealant composition or as a second initiator in combination with the photoinitiator described above. A peroxide initiator can be useful, for example, when at least a portion of the curable sealant composition is in shadow (e.g., between opaque substrates) and/or if the curable sealant composition is highly filled with an opaque filler. Organic peroxides can also be useful, for example, when the curable sealant composition includes a polysulfide oligomer or polymer. In these cases, the organic peroxide can serve as an oxidizing agent that can minimize the degradation or interchanging of disulfide bonds in the sealant network.

In some embodiments, the organic peroxide is an organic hydroperoxide. Organic hydroperoxides have the general structure R′—OOH, wherein R′ is an alkyl group, aryl group, arylalkylene group, alkylarylene group, alkylarylenealkylene group, or a combination thereof. Examples of useful organic hydroperoxides include cumene hydroperoxide, tent-butyl hydroperoxide, tert-amyl hydroperoxide, 1,1,3,3-tetramethylbutyl hydroperoxide, isopropylcumyl hydroperoxide, p-menthane hydroperoxide (i.e., 1-methyl-1-(4-methylcyclohexyl)ethyl hydroperoxide), diisopropylbenzene hydroperoxide (e.g., 3,5-diisopropylhydroperoxide). In some embodiments, the organic hydroperoxide includes a ketone peroxide (e.g., methyl ethyl ketone peroxide, acetone peroxide, and cyclohexanone peroxide).

When used as an initiator to cure the curable sealant composition, the organic peroxide can be used in combination with an amine, wherein the peroxide and the amine together provide a peroxide-amine redox initiator. In some embodiments, the amine is a tertiary amine. In some embodiments, the amine is selected from the group consisting of dihydroxyethyl-p-toluidine, N,N-diisopropylethylamine, and N,N,N′,N″,N″-pentamethyl-diethylenetriamine.

While organic hydroperoxides tend to be some of the more stable peroxides and require some of the highest temperatures for thermal initiation, we have found that in the presence of a polythiol and unsaturated compound in the composition of the present disclosure, the organic hydroperoxide can initiate curing at room temperature. In some embodiments, curable sealant compositions that comprise an organic hydroperoxide further comprise a nitrogen-containing base. In some embodiments, a combination of a nitrogen-containing base and an organic hydroperoxide can be considered a redox initiator. The nitrogen atom(s) in the nitrogen-containing base can be bonded to alkyl groups, aryl groups, arylalkylene groups, alkylarylene, alkylarylenealkylene groups, or a combination thereof. The nitrogen-containing base can also be a cyclic compound, which can include one or more rings and can be aromatic or non-aromatic (e.g., saturated or unsaturated). Cyclic nitrogen-containing bases can include a nitrogen as at least one of the atoms in a 5- or 6-membered ring. In some embodiments, the nitrogen-containing base includes only carbon-nitrogen, nitrogen-hydrogen, carbon-carbon, and carbon-hydrogen bonds. In some embodiments, the nitrogen-containing base can be substituted with at least one of alkoxy, aryl, arylalkylenyl, haloalkyl, haloalkoxy, halogen, nitro, hydroxy, hydroxyalkyl, mercapto, cyano, aryloxy, arylalkyleneoxy, heterocyclyl, or hydroxyalkyleneoxyalkylenyl. In some embodiments, the nitrogen-containing base is a tertiary amine. Examples of useful tertiary amines include triethylamine, dimethylethanolamine, benzyldimethylamine, dimethylaniline, tribenzylamine, triphenylamine, N,N-dimethyl -para-toluidine, N,N-dimethyl-ortho-toluidine, tetramethylguanidine (TMG), 1,8-diazabicyclo[5.4.0]undec-7-ene (DBU), 1,5-diazabicyclo[4.3.0]non-5-ene (DBN), 1,4-diazabicyclo[2.2.2]octane (DABCO), quinuclidine, dimethylaminomethyl phenol, tris(dimethylaminomethyl)phenol, N,N-dihydroxyethyl-p-toluidine, N,N-diisopropylethylamine, and N, N,N′,N″,N″-pentamethyl-diethylenetriamine. Useful nitrogen-containing bases also include guanidines such as diphenylguanidine (DPG). In some embodiments, the nitrogen-containing base comprises a substituted or unsubstituted nitrogen-containing ring. In some embodiments, the substituted or unsubstituted nitrogen-containing ring has 5 or 6 atoms in the ring. The substituted or unsubstituted nitrogen-containing ring can be aromatic or nonaromatic and can have up to 4 nitrogen atoms in the ring. The ring can optionally include other heteroatoms (e.g., S and O). Substituted aromatic or nonaromatic rings can be substituted by one or more substituents independently selected from the group consisting of alkyl, aryl, arylalkylenyl, alkoxy, haloalkyl, haloalkoxy, halogen, nitro, hydroxy, hydroxyalkyl, mercapto, cyano, aryloxy, arylalkyleneoxy, heterocyclyl, hydroxyalkyleneoxyalkylenyl, amino, alkylamino, dialkylamino, (dialkylamino)alkyleneoxy, and oxo. The alkyl substituent can be unsubstituted or substituted by at least one of alkoxy having up to 4 carbon atoms, halo, hydroxy, or nitro. In some embodiments, the aryl or arylalkylenyl is unsubstituted or substituted by at least one of alkyl having up to 4 carbon atoms, alkoxy having up to 4 carbon atoms, halo, hydroxy, or nitro. In some embodiments, the nitrogen-containing base is a substituted or unsubstituted pyridine, pyrazine, imidazole, pyrazole, tetrazole, triazole, oxazole, thiazole, pyrimidine, pyridazine, triazine, tetrazine, or pyrrole. Any of these may be substituted with halogen (e.g., iodo, bromo, chloro, fluoro), alkyl (e.g., having from 1 to 4, 1 to 3, or 1 to 2 carbon atoms), arylalkylenyl (e.g., benzyl), or aryl (phenyl). In some embodiments, the nitrogen-containing base, is a substituted or unsubstituted imidazole or pyrazole. The imidazole or pyrazole may be substituted with halogen (e.g., iodo, bromo, chloro, fluoro), alkyl (e.g., having from 1 to 4, 1 to 3, or 1 to 2 carbon atoms), arylalkylenyl (e.g., benzyl), or aryl (phenyl). Examples of useful nitrogen-containing rings include 1-benzylimidazole, 1,2-dimethylimidazole, 4-iodopyrazole, 1-methylbenzimidazole, 1-methylpyrazole, 3-methylpyrazole, 4-phenylimidazole, and pyrazole.

Organic peroxides, in some embodiments, organic hydroperoxides, can be added in any amount suitable to initiate curing of the curable sealant composition. In some embodiments, the organic peroxide is present in an amount in a range from 0.05 weight percent to about 10 weight percent (in some embodiments, 0.1 weight percent to 5 weight percent, or 0.5 weight percent to 5 weight percent). The organic peroxide and its amount may be selected to provide the composition with a desirable open time. In some embodiments, the composition has an open time of at least 10 minutes, at least 30 minutes, at least one hour, or at least two hours.

The nitrogen-containing base, which in some embodiments, provides a redox curing system in the presence of an organic peroxide, and its amount may be selected to provide the composition with a desirable open time. In some embodiments, the composition has an open time of at least 10 minutes, at least 30 minutes, at least one hour, or at least two hours. The amount of the nitrogen-containing base and its conjugate acid pKa can both affect the open time. A composition with a smaller amount of a nitrogen-containing base having a higher pKa may have the same open time as a composition having a larger amount of a nitrogen-containing base having a lower pKa. In some embodiments, the nitrogen-containing base is present in an amount in a range from 0.05 weight percent to about 10 weight percent (in some embodiments, 0.1 weight percent to 5 weight percent, or 0.5 weight percent to 5 weight percent).

In some embodiments, when used as an initiator to cure the curable sealant composition, the organic peroxide, including any of those described above, can be used in combination with an organoborane-amine complex. The organoborane-amine complex is a latent form of an organoborane which is liberated upon decomplexing the base with a compound that reacts with the base, such as an acid or its equivalent. The free organoborane is an initiator capable of initiating free-radical polymerization of the curable sealant composition, for example.

The organoborane portion of the organoborane-amine complex is shown in Formula III (below):

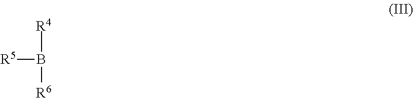

wherein R⁴, R⁵, and R⁶ are organic groups (typically having 30 atoms or less, or 20 atoms or less, or 10 atoms or less). In some embodiments of Formula III, R⁴ represents an alkyl group having from 1 to 10 carbon atoms, or from 1 to 6 carbon atoms, or from 1 to 5 carbon atoms, or from 1 to 4 carbon atoms, or from 2 to 4 carbon atoms, or from 3 to 4 carbon atoms.

In some embodiments of Formula III, R⁵ and R⁶ independently represent (i.e., they may be the same or different): alkyl groups having 1 to 10 carbon atoms (or from 1 to 6 carbon atoms, or from 1 to 5 carbon atoms, or from 1 to 4 carbon atoms, or from 2 to 4 carbon atoms, or from 3 to 4 carbon atoms); cycloalkyl groups having 3 to 10 carbon atoms; aryl groups having from 6 to 12 carbon atoms (e.g., phenyl); or aryl groups having from 6 to 12 carbon atoms (e.g., phenyl) substituted with alkyl groups having 1 to 10 carbon atoms (or from 1 to 6 carbon atoms, or from 1 to 5 carbon atoms, or from 1 to 4 carbon atoms, or from 2 to 4 carbon atoms, or from 3 to 4 carbon atoms), or cycloalkyl groups having 3 to 10 carbon atoms. Any two of R⁴, R⁵, and R⁶ groups may optionally be part of a ring (e.g., two groups can combine to form a ring).

The organoborane initiator is complexed with a basic complexing agent (i.e., a base that complexes with the organoborane) to form a stable organoborane-amine complex. The organoborane-amine complex may be represented by Formula IV (below):

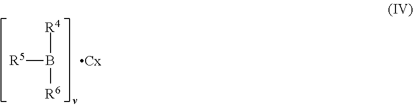

wherein R⁴, R⁵, and R⁶ are as previously defined, and Cx represents a complexing agent selected from a compound having one or more amine groups and optionally one or more alkoxyl groups; and v is a positive number. The value of v is selected so as to render the organoborane-amine complex stable under ambient conditions. For example, when the organoborane-amine complex is stored in a capped vessel at about 20° C. to 22° C. and under otherwise ambient conditions (i.e., the vessel is capped in an ambient air environment and not under vacuum or an inert atmosphere), the complex remains useful as an initiator for at least two weeks. In some cases, the complexes may be readily stored under these conditions for many months, and up to a year or more. In some embodiments, the value of v is typically at least 0.1, or at least 0.3, or at least 0.5, or at least 0.8, or at least 0.9 and, up to 2, or up to 1.5, or up to 1.2. In some embodiments, v is in a range of 0.1 to 2, or in a range of 0.5 to 1.5, or in a range of 0.8 to 1.2, or in a range of 0.9 to 1.1, or 1.

In Formulas III and IV, an alkyl group may be straight chain or branched. In some embodiments, a ring formed by two groups of R⁴, R⁵, and R⁶ may be bridged by the boron atom in Formula III or Formula IV. The organoborane-amine complex typically does not include a thiol group.

Examples of useful organoboranes of the organoborane-amine complexes are trimethylborane, triethylborane, tri-n-propylborane, triisopropylborane, tri-n-butylborane, triisobutylborane, and tri-sec-butylborane.

Useful basic complexing agents (Cx) include, for example, amines, aminoalcohols, aminoethers and compounds that contain a combination of such functionality (e.g., an amino group and an alkoxy group). Sufficient complexing agent is provided to ensure stability of the organoborane-amine complex under ambient conditions. Insufficient complexing agent could leave free organoborane, a material that tends to be pyrophoric. In practice, to ensure stability of the complex at ambient conditions, the compound that serves as the complexing agent is often in excess, i.e., some of the compound is free or not complexed in the composition. The amount of excess basic complexing agent is chosen to ensure stability of the complex under ambient conditions while still achieving desired performance such as cure rate of the polymerizable composition and mechanical properties of the cured composition. For example, there may be up to 100 percent molar excess, or up to 50 percent molar excess, or up to 30 percent molar excess of the basic complexing agent relative to the organoborane. Often, there is 10 to 30% molar excess of the basic complexing agent relative to the organoborane.

Useful basic complexing agents include, for example, amines and aminoethers. The amine compounds may have primary and/or secondary amino group(s), for example.

Amine complexing agents (Cx) may be provided by a wide variety of materials having one or more primary or secondary amine groups, including blends of different amines. Amine complexing agents may be a compound with a single amine group or may be a polyamine (i.e., a material having multiple amine groups such as two or more primary, secondary, or tertiary amine groups). Suitable polyamines preferably have at least one amine group that is a primary and/or secondary amine group.

The organoborane-amine complex may be readily prepared using known techniques, as described, for example, in U.S. Pat. No. 5,616,796 (Pocius et al.), U.S. Pat. No. 5,621,143 (Pocius), U.S. Pat. No. 6,252,023 (Moren), U.S. Pat. No. 6,410,667 (Moren), and U.S. Pat. No. 6,486,090 (Moren).

Suitable organoborane-amine complexes are available from suppliers such as BASF and AkzoNobel. TEB-DAP (triethylborane-1,3-diaminopropane (or 1,3-propanediamine) complex), TnBB-MOPA (tri-n-butylborane-3-methoxypropylamine complex), TEB-DETA (triethylborane-diethylenetriamine complex), TnBB-DAP (tri-n-butylborane-1,3-diaminopropane complex), and TsBB-DAP (tri-sec-butylborane-1,3-diaminopropane complex) are all available from BASF (Ludwigshafen, Germany). TEB-HMDA (triethylborane-hexamethylenediamine (also 1,6-hexanediamine or 1,6-diaminohexane) complex) is available from AkzoNobel, Amsterdam, The Netherlands.

The organoborane-amine complex is generally employed in an effective amount, which is an amount large enough to permit reaction (i.e., curing by polymerizing and/or crosslinking) to readily occur to obtain a polymer of sufficiently high molecular weight for the desired end use. If the amount of organoborane produced is too low, then the reaction may be incomplete. On the other hand, if the amount is too high, then the reaction may proceed too rapidly to allow for effective mixing and use of the resulting composition. Useful rates of reaction will typically depend at least in part on the method of applying the composition to a substrate. Thus, a faster rate of reaction may be accommodated by using a high-speed automated industrial applicator rather than by applying the composition with a hand applicator or by manually mixing the composition.

Within these parameters, an effective amount of the organoborane-amine complex is typically an amount that provides at least 0.003 percent by weight of boron, or at least 0.008 percent by weight of boron, or at least 0.01 percent by weight of boron. An effective amount of the organoborane-amine complex is typically an amount that provides up to 1.5 percent by weight of boron, or up to 0.5 percent by weight of boron, or up to 0.3 percent by weight of boron. The percent by weight of boron in a composition is based on the total weight of the polymerizable material.

Alternatively stated, an effective amount of the organoborane-amine complex is at least 0.1 percent by weight, or at least 0.5 percent by weight. An effective amount of the organoborane-amine complex is up to 10 percent by weight, or up to 5 percent by weight, or up to 3 percent by weight. The percent by weight of the organoborane-amine complex in a composition is based on the total weight of the polymerizable material.

A decomplexing agent (e.g., mineral acids, Lewis acids, carboxylic acids, acid anhydrides, acid chlorides, sulfonyl chlorides, phosphonic acids, isocyanates, aldehydes, 1,3-dicarbonyl compounds, acrylates, and epoxies) may be included to activate the organoborane-amine complex, however, it is presently discovered that it is generally not needed; for example, the curable sealant composition may contain less than 1, less than 0.1, or less than 0.01 weight percent of the decomplexing agent, or even be free of the decomplexing agent. As used herein, the term “decomplexing agent” refers to a compound capable of liberating the organoborane from its complexing agent, thereby enabling initiation of the reaction (curing by polymerizing and/or crosslinking) of the polymerizable material of the composition. Decomplexing agents may also be referred to as “activators” or “liberators” and these terms may be used synonymously herein.

In some embodiments, the curable sealant composition includes a polyepoxide having more than one epoxide group. Epoxides are useful, for example, as curing agents for polythiols. In some embodiments, the polyepoxide includes at least two epoxide groups. Generally, in order to achieve chemical crosslinking between polymer chains, greater than two thiol groups and/or greater than two epoxide groups are present in at least some of the polythiol and polyepoxide molecules, respectively. When using a polythiol having two thiol groups, for example, a mixture of polyepoxides may be useful in which at least one polyepoxide has two epoxide groups, and at least one polyepoxide has at least three epoxide groups. Mixtures of polyepoxides and/or polythiols having at least 5 percent functional equivalents of epoxide groups contributed by polyepoxides having at least three epoxide groups or at least 5 percent functional equivalents of thiol groups contributed by polythiols having at least three thiol groups may be useful. A variety of polyepoxides having more than one epoxide group are useful in the method according to the present disclosure. In some embodiments, the polyepoxide is monomeric. In some embodiments, the polyepoxide is oligomeric or polymeric (that is, an epoxy resin). A monomeric polyepoxide may be an alkylene, arylene, alkylarylene, arylalkylene, or alkylenearylalkylene having at least two epoxide groups, wherein any of the alkylene, alkylarylene, arylalkylene, or alkylenearylalkylene are optionally interrupted by one or more ether (i.e., —O—), thioether (i.e., —S—), or amine (i.e., —NR¹—) groups and optionally substituted by alkoxy, hydroxyl, or halogen (e.g., fluoro, chloro, bromo, iodo). Useful monomeric polyepoxides may be diepoxides or polyepoxides with more than 2 (in some embodiments, 3 or 4) epoxide groups. An epoxy resin may be prepared by chain-extending any of such polyepoxides.

Some useful polyepoxides are aromatic. Useful aromatic polyepoxides and epoxy resins typically contain at least one (in some embodiments, at least 2, in some embodiments, in a range from 1 to 4) aromatic ring (e.g., phenyl group) that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For polyepoxides and epoxy resin repeating units containing two or more aromatic rings, the rings may be connected, for example, by a branched or straight-chain alkylene group having 1 to 4 carbon atoms that may optionally be substituted by halogen (e.g., fluoro, chloro, bromo, iodo). In some embodiments, the aromatic polyepoxide or epoxy resin is a novolac. In these embodiments, the novolac epoxy may be a phenol novolac, an ortho-, meta-, or para-cresol novolac, or a combination thereof. In some embodiments, the aromatic polyepoxide or epoxy resin is a bisphenol diglycidyl ether, wherein the bisphenol (i.e., —O—C₆H₅—CH₂—C₆H₅—O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. In some embodiments, the polyepoxide is a novolac epoxy resin (e.g., phenol novolacs, ortho-, meta-, or para-cresol novolacs or combinations thereof), a bisphenol epoxy resin (e.g., bisphenol A, bisphenol F, halogenated bisphenol epoxies, and combinations thereof), a resorcinol epoxy resin, and combinations of any of these. Examples of useful aromatic monomeric polyepoxides include the diglycidyl ethers of bisphenol A and bisphenol F and tetrakisglycidyl-4-phenylolethane and mixtures thereof.

Some useful polyepoxides are non-aromatic. The non-aromatic epoxy can include a branched or straight-chain alkylene group having 1 to 20 carbon atoms optionally interrupted with at least one —O— and optionally substituted by hydroxyl. In some embodiments, the non-aromatic epoxy can include a poly(oxyalkylene) group having a plurality (x) of oxyalkylene groups, OR^{1′}, wherein each R^{1′} is independently C₂ to C₅ alkylene, in some embodiments, C₂ to C₃ alkylene, x is 2 to about 6, 2 to 5, 2 to 4, or 2 to 3. Examples of useful non-aromatic monomeric polyepoxides include ethylene glycol diglycidyl ether, propylene glycol diglycidyl ether, diethylene glycol diglycidyl ether, dipropylene glycol diglycidyl ether, polyethylene glycol diglycidyl ether, polypropylene glycol diglycidyl ether, glycerol diglycidyl ether, propanediol diglycidyl ether, butanediol diglycidyl ether, and hexanediol diglycidyl ether. Examples of useful polyepoxides having more than two epoxide groups include glycerol triglycidyl ether, and polyglycidyl ethers of 1,1,1-trimethylolpropane, pentaerythritol, and sorbitol. Other examples of useful polyepoxides include glycidyl ethers of cycloaliphatic alcohols (e.g., 1,4-cyclohexanedimethanol, bis(4-hydroxycyclohexyl)methane or 2,2-bis(4-hydroxycyclohexyl)propane), cycloaliphatic epoxy resins (e.g., bis(2,3-epoxycyclopentyl) ether, 2,3-epoxycyclopentyl glycidyl ether, 1,2-bis(2,3-epoxycyclopentyloxy)ethane and 3,4-epoxycyclohexylmethyl 3′,4′-epoxycyclohexanecarboxylate), and hydantoin diepoxide. Examples of polyepoxides having amine groups include poly(N-glycidyl) compounds obtainable by dehydrochlorinating the reaction products of epichlorohydrin with amines containing at least two amine hydrogen atoms. These amines are, for example, aniline, n-butylamine, bis(4-aminophenyl)methane, m-xylylenediamine or bis(4-methylaminophenyl)methane. Examples of polyepoxides having thioether groups include di-S-glycidyl derivatives of dithiols (e.g., ethane-1,2-dithiol or bis(4-mercaptomethylphenyl) ether).

In some embodiments of compositions useful in the methods according to the present disclosure, the polyepoxide is an oligomeric or polymeric diepoxide. In some embodiments, epoxides may be chain extended to have any desirable epoxy equivalent weight. Chain extending epoxy resins can be carried out by reacting a monomeric diepoxide, for example, with a diol in the presence of a catalyst to make a linear polymer. In some embodiments, the resulting epoxy resin (e.g., either an aromatic or non-aromatic epoxy resin) may have an epoxy equivalent weight of at least 150, 170, 200, or 225 grams per equivalent. In some embodiments, the aromatic epoxy resin may have an epoxy equivalent weight of up to 2000, 1500, or 1000 grams per equivalent. In some embodiments, the aromatic epoxy resin may have an epoxy equivalent weight in a range from 150 to 2000, 150 to 1000, or 170 to 900 grams per equivalent. Epoxy equivalent weights may be selected, for example, so that the epoxy resin may be used as a liquid.

Mixtures of polythiols and mixtures of polyepoxides, including any of those described above, may also be useful. Typically, the amounts of the polythiol(s) and polyepoxide(s) are selected for the composition so that there is a stoichiometric equivalence of mercaptan groups and epoxide groups. The stoichiometry expressed as a ratio of —SH groups/epoxide groups can be in the range of 0.8 to 1.2, 0.9 to 1.1, or 0.95 to 1.05, although this is not a requirement.

Photoinitiators suitable for curing a polythiol with a curing agent comprising polyepoxide having more than one epoxide group include a photolatent base. A photolatent base photochemically generates a base that can catalyze the reaction between the polythiol and the polyepoxide. In some embodiments of the method disclosed herein, the base is a first amine. Photolatent bases are also useful, for example, for curing a polythiol with a curing agent comprising a Michael acceptor.

A variety of photolatent bases can be useful in the method of the present disclosure. Many useful photolatent bases, any of which may be useful for practicing the present disclosure, have been reviewed in Suyama, K. and Shirai, M., “Photobase Generators: Recent Progress and Application Trend in Polymer Systems” Progress in Polymer Science 34 (2009) 194-209. Photolatent bases useful for practicing the present disclosure include photocleavable carbamates (e.g., 9-xanthenylmethyl, fluorenylmethyl, 4-methoxyphenacyl, 2,5-dimethylphenacyl, benzyl, and others), which have been shown to generate primary or secondary amines after photochemical cleavage and liberation of carbon dioxide. Other photolatent bases described in the review as useful for generating primary or secondary amines include certain O-acyloximes, sulfonamides, and formamides. Acetophenones, benzophenones, and acetonaphthones bearing quaternary ammonium substituents are reported to undergo photocleavage to generate tertiary amines in the presence of a variety of counter cations (borates, dithiocarbamates, and thiocyanates). Examples of these photolatent ammonium salts are N-(benzophenonemethyl)tri-N-alkyl ammonium triphenylborates. Certain sterically hindered α-aminoketones are also reported to generate tertiary amines.

Recently, quaternary ammonium salts made from a variety of amines and phenylglyoxylic acid have been shown to generate amines that catalyze a thiol/epoxy reaction after exposure to UV light. (See Salmi, H., et al. “Quaternary Ammonium Salts of Phenylglyoxylic acid as Photobase Generators for Thiol-Promoted Epoxide Photopolymerization” Polymer Chemistry 5 (2014) 6577-6583.) Such salts are also suitable as photolatent bases useful for practicing the present disclosure.

In some embodiments, the photolatent base useful for practicing the present disclosure is a 1,3-diamine compound represented by the formula N(R₇ₐ)(R₆ₐ)—CH(R₅ₐ)—N(R₄ₐ)—C(R₁ₐ)(R₂ₐ)(R₃ₐ) such as those described in U.S. Pat. No. 7,538,104 (Baudin et al.). Such compounds can be considered arylalkylenyl substituted reduced amidines or guanidines. In formula N(R₇ₐ)(R₆ₐ)—CH(R₅ₐ)—N(R₄ₐ)—C(R₁ₐ)(R₂ₐ)(R₃ₐ), R₁ₐ is selected from aromatic radicals, heteroaromatic radicals, and combinations thereof that absorb light in the wavelength range from 200 nm to 650 nm and that are unsubstituted or substituted one or more times by at least one monovalent group selected from alkyl, alkenyl, alkynyl, haloalkyl, —NO₂, —NR₁₀ₐ R₁₁ₐ, —CN, —OR₁₂ₐ, —SR₁₂ₐ, —C(O)R₁₃ₐ, —C(O)OR₁₄ₐ, halogen, groups of the formula N(R₇ₐ)(R₆ₐ)—CH(R₅ₐ)—N(R₄ₐ)—C(R₂ₐ)(R₃ₐ)— where R₂ₐ-R₇ₐ are as defined below, and combinations thereof, and that upon absorption of light in the wavelength range from 200 nm to 650 nm bring about a photoelimination that generates an amidine or guanidine. R₂ₐ and R₃ₐ are each independently selected from hydrogen, alkyl, phenyl, substituted phenyl (that is, substituted one or more times by at least one monovalent group selected from alkyl, —CN, —OR₁₂ₐ, —SR₁₂ₐ, halogen, haloalkyl, and combinations thereof), and combinations thereof; R₅ₐ is selected from alkyl, —NR₈ₐR₉ₐ, and combinations thereof; R₄ₐ, R₆ₐ, R₇ₐ, R₈ₐ, R₉ₐ, R₁₀ₐ and R₁₁ₐ are each independently selected from hydrogen, alkyl, and combinations thereof; or R₁ₐ and R₆ₐ together form a C₂-C₁₂ alkylene bridge that is unsubstituted or is substituted by one or more monovalent groups selected from C₁-C₄ alkyl radicals and combinations thereof; or R₅ₐ and R₇ₐ, independently of R₄ₐ and R₆ₐ, together form a C₂-C₁₂ alkylene bridge that is unsubstituted or is substituted by one or more monovalent groups selected from C₁-C₄ alkyl radicals and combinations thereof; or, if R₅ₐ is —NR₈ₐR₉ₐ, then R₇ₐ and R₉ₐ together form a C₂-C₁₂ alkylene bridge that is unsubstituted or is substituted by one or more monovalent groups selected from C₁-C₄ alkyl radicals and combinations thereof; and R₁₂ₐ, R₁₃ₐ, and R₁₄ₐ are each independently selected from hydrogen, alkyl, and combinations thereof. Any of the alkyl and haloalkyl groups above can be linear or branched and, in some embodiments, contain 1 to about 19 carbon atoms (in some embodiments, 1 to about 18, 1 to about 12, or 1 to about 6 carbon atoms). In some embodiments, halogen atoms are chlorine, fluorine, and/or bromine (in some embodiments, chlorine and/or fluorine). The alkenyl groups can be linear or branched and, in some embodiments, contain 2 to about 18 carbon atoms (in some embodiments, 2 to about 12 or 2 to about 6 carbon atoms). The alkynyl groups can be linear or branched and, in some embodiments, contain 2 to about 18 carbon atoms (in some embodiments, 2 to about 12 or 2 to about 6 carbon atoms).

In some embodiments of formula N(R₇ₐ)(R₆ₐ)—CH(R₅ₐ)—N(R₄ₐ)—C(R₁ₐ)(R₂ₐ)(R₃ₐ), R₁ₐ is selected from substituted and unsubstituted phenyl, naphthyl, phenanthryl, anthryl, pyrenyl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, anthraquinonyl, dibenzofuryl, chromenyl, xanthenyl, thioxanthyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazolyl, furazanyl, terphenyl, stilbenyl, fluorenyl, phenoxazinyl, and combinations thereof, any of these being unsubstituted or substituted one or more times by C₁-C₁₈ alkyl, C₂-C₁₈ alkenyl, C₂-C₁₈ alkynyl, C₁-C₁₈ haloalkyl, —NO₂, —NR₁₀ₐ R₁₁ₐ, —CN, —OR₁₂ₐ, —SR₁₂ₐ, —C(O)R₁₃ₐ, —C(O)OR₁₄ₐ, halogen, a radical of the formula N(R₇ₐ)(R₆ₐ)—CH(R₅ₐ)—N(R₄ₐ)—C(R₂ₐ)(R₃ₐ)—, or a combination thereof, where R₂ₐ-R₇ₐ and R₁₀ₐ-R₁₄ₐ are as defined above. In some embodiments of formula N(R₇ₐ)(R₆ₐ)—CH(R₅ₐ)—N(R₄ₐ)—C(R₁ₐ)(R₂ₐ)(R₃ₐ), R₁ₐ is a substituted or unsubstituted biphenylyl radical, wherein each phenyl group is independently substituted with from zero to three (preferably, zero or one) substituents selected from C₁-C₁₈ alkyl, C₂-C₁₈ alkenyl, —OH, —CN, —OR₁₀ₐ, —SR₁₀ₐ, halogen, radicals of the formula N(R₇ₐ)(R₆ₐ)—CH(R₅ₐ)—N(R₄ₐ)—C(R₂ₐ)(R₃ₐ)—, and combinations thereof, where R₂ₐ-R₇ₐ and R₁₀ₐ-R₁₄ₐ are as defined above. In some embodiments of formula N(R₇ₐ)(R₆ₐ)—CH(R₅ₐ)—N(R₄ₐ)—C(R₁ₐ)—(R₂ₐ)(R₃ₐ), R₁ₐ is selected from phenyl, 3-methoxyphenyl, 4-methoxyphenyl, 2,4,6-trimethoxyphenyl, 2,4-dimethoxyphenyl, and combinations thereof.

In some embodiments of formula N(R₇ₐ)(R₆ₐ)—CH(R₅ₐ)—N(R₄ₐ)—C(R₁ₐ)(R₂ₐ)(R₃ₐ), R₂ₐ and R₃ₐ each are independently selected from hydrogen, C₁-C₆alkyl, and combinations thereof (in some embodiments, both are hydrogen); R₄ₐ and R₆ₐ together form a C₂-C₆ alkylene (in some embodiments, C₃ alkylene) bridge that is unsubstituted or is substituted by one or more groups selected from C₁-C₄ alkyl radicals and combinations thereof; and/or R₅ₐ and R₇ₐ together form a C₂-C₆ alkylene (in some embodiments, C₃ or C₅ alkylene) bridge that is unsubstituted or is substituted by one or more groups selected from C₁-C₄ alkyl radicals and combinations thereof, or, if R₅ₐ is —NR₈ₐ R₉ₐ, R₉ₐ and R₇ₐ together form a C₂-C₆ alkylene bridge that is unsubstituted or substituted by one or more groups selected from C₁-C₄ alkyl radicals and combinations thereof.

Examples of suitable photolatent bases useful for practicing the present disclosure include 5-benzyl -1,5-diazabicyclo[4.3.0]nonane, 5-(anthracen-9-yl-methyl)-1,5-diaza[4.3.0]nonane, 5-(2′-nitrobenzyl)-1,5-diazabicyclo[4.3.0]nonane, 5-(4′-cyanobenzyl)-1,5-diazabicyclo[4.3.0]nonane, 5-(3′-cyanobenzyl)-1,5-diazabicyclo[4.3.0]nonane, 5-(anthraquinon-2-yl-methyl)-1,5-diaza[4.3.0]nonane, 5-(2′-chlorobenzyl)-1,5-diazabicyclo[4.3.0]nonane, 5-(4′-methylbenzyl)-1,5-diazabicyclo[4.3.0]nonane, 5-(2′,4′,6′-trimethylbenzyl)-1,5-diazabicyclo[4.3.0]nonane, 5-(4′-ethenylbenzyl)-1,5-diazabicyclo[4.3.0]nonane, 5-(3′-trimethylbenzyl)-1,5-diazabicyclo[4.3.0]nonane, 5-(2′,3′-dichlorobenzyl)-1,5-diazabicyclo[4.3.0]nonane, 5-(naphth-2-yl-methyl-1,5-diazabicyclo[4.3.0]nonane, 1,4-bis(1,5-diazabicyclo[4.3.0]nonanylmethyl)benzene, 8-benzyl-1,8-diazabicyclo[5.4.0]undecane, 8-benzyl-6-methyl-1,8-diazabicyclo[5.4.0]undecane, 9-benzyl-1,9-diazabicyclo[6.4.0]dodecane, 10-benzyl-8-methyl-1,10-diazabicyclo[7.4.0]tridecane, 11-benzyl-1,11-diazabicyclo[8.4.0]tetradecane, 8-(2′-chlorobenzyl)-1,8-diazabicyclo[5.4.0]undecane, 8-(2′,6′-dichlorobenzyl)-1,8-diazabicyclo[5.4.0]undecane, 4-(diazabicyclo[4.3.0]nonanylmethyl)-1,1′-biphenyl, 4,4′-bis(diazabicyclo [4.3.0] nonanylmethyl)-11′-biphenyl, 5-benzyl-2-methyl-1,5-diazabicyclo [4.3.0]nonane, 5-benzyl-7-methyl-1,5,7-triazabicyclo[4.4.0]decane, and combinations thereof. Such compounds can be made, for example, using the methods described in U.S. Pat. No. 7,538,104 (Baudin et al.), assigned to BASF, Ludwigshafen, Germany. An example of a photolatent base is available from BASF under the trade designation “CGI 90”, which is reported to generate 1,5-diazabicyclo[4.3.0]non-5-ene (DBN) upon exposure to actinic radiation (see, e.g., US2013/0345389 (Cai et al.).

Other suitable photolatent bases useful for practicing the present disclosure and/or for practicing the methods disclosed herein include those described in U.S. Pat. No. 6,410,628 (Hall-Goulle et al.), U.S. Pat. No. 6,087,070 (Turner et al.), U.S. Pat. No. 6,124,371 (Stanssens et al.), and U.S. Pat. No. 6,057,380 (Birbaum et al.), and U.S. Pat. Appl. Pub. No. 2011/01900412 (Studer et al.).

A curable sealant including a photolatent base can be packaged as a one-part product including the photolatent base, or a two-part product in which at least one of the parts includes the photolatent base and can be mixed just before it is applied to surface of the aircraft component. The photolatent base can be added to the curable sealant in any amount suitable to initiate curing. In some embodiments, the photolatent base is present in an amount in a range from 0.05 weight percent to about 5 weight percent (in some embodiments, 0.1 weight percent to 2.5 weight percent, or 0.1 weight percent to 2 weight percent), based on the total weight of the curable sealant.

In some embodiments of the method according to the present disclosure, curable sealant compositions comprising a photolatent base also include a second amine. The second amine can be useful, for example, when at least a portion of the curable sealant composition is in shadow (e.g., between opaque substrates or otherwise shielded from the light source) and/or if the curable sealant composition is highly filled with an opaque filler. The second amine may be the same or different from the first amine.

In some embodiments, a temperature sufficient for the second amine to at least partially cure the curable sealant is ambient temperature (that is, no external heat source is necessary). The second amine can also be useful for curing a curable sealant composition in the absence of a photolatent base.

The first amine (generated by the photolatent base) and second amine can independently be any compound including one to four basic nitrogen atoms that bear a lone pair of electrons. The first amine and second amine can independently include primary, secondary, and tertiary amine groups. The nitrogen atom(s) in the first amine and second amine can be bonded to alkyl groups, aryl groups, arylalkylene groups, alkylarylene, alkylarylenealkylene groups, or a combination thereof. The first amine and second amine can also be cyclic amines, which can include one or more rings and can be aromatic or non-aromatic (e.g., saturated or unsaturated). One or more of the nitrogen atoms in the amine can be part of a carbon-nitrogen double bond. While in some embodiments, the first amine and second amine independently include only carbon-nitrogen, nitrogen-hydrogen, carbon-carbon, and carbon-hydrogen bonds, in other embodiments, the first amine and second amine can include other functional groups (e.g., hydroxyl or ether group). However, it is understood by a person skilled in the art that a compound including a nitrogen atom bonded to a carbonyl group is an amide, not an amine, and has different chemical properties from an amine. The first amine and second amine can include carbon atoms that are bonded to more than one nitrogen atom. Thus, the first amine and second amine can independently be a guanidine or amidine. As would be understood by a person skilled in the art, a lone pair of electrons on one or more nitrogens of the first amine and second amine distinguishes them from quaternary ammonium compounds, which have a permanent positive charge regardless of pH.

Examples of useful first and second amines include propylamine, butylamine, pentylamine, hexylamine, triethylamine, dimethylethanolamine, benzyldimethylamine, dimethylaniline, tribenzylamine, triphenylamine, tetramethylguanidine (TMG), 1,8-diazabicyclo[5.4.0]undec-7-ene (DBU), 1,5-diazabicyclo[4.3.0]non-5-ene (DBN), 1,4-diazabicyclo[2.2.2]octane (DABCO), quinuclidine, diphenylguanidine (DPG), dimethylaminomethyl phenol, and tris(dimethylaminomethyl)phenol. In some embodiments, the first amine and second amine are each independently tertiary amines, amidines, or guanidines.

The second amine and its amount may be selected to provide the curable sealant with a desirable amount of open time (that is, the length of time it takes for the curable sealant to become at least partially gelled) after it is mixed or thawed. In some embodiments, the composition has an open time of at least 10 minutes, at least 30 minutes, at least one hour, or at least two hours. The amount of the second amine and its conjugate acid pKa both affect the open time. A composition with a smaller amount of a second amine having a higher pKa may have the same open time as a composition having a larger amount of a second amine having a lower pKa. For a second amine with a moderate conjugate acid pKa value in a range from about 7 to about 10, an amount of second amine in a range from 0.05 weight percent to about 10 weight percent (in some embodiments, 0.05 weight percent to 7.5 weight percent, or 1 weight percent to 5 weight percent) may be useful. For a second amine with a higher conjugate acid pKa value of about 11 or more, an amount of second amine in a range from 0.005 weight percent to about 3 weight percent (in some embodiments, 0.05 weight percent to about 2 weight percent) may be useful. In some embodiments in which the second amine is different from the first amine, the second amine has a lower conjugate acid pKa value than the first amine. This may be useful, for example, for achieving a desirable amount of open time and a desirably fast formation of a non-tacky skin. In some embodiments in which the second amine is different from the first amine, the first amine and the second amine have the same conjugate acid pKa value.

In some embodiments, the second amine may be phase-separated in the curable sealant composition. In these embodiments, the second amine can be a solid (e.g., dicyandiamide), present in a solid adduct (e.g., such as an adduct of an amine and an epoxy resin), or segregated within a solid (e.g., a semi-crystalline polymer). As a phase-separated amine, the second amine is not reactive with or reacts very slowly with the curable components in the sealant at ambient temperature. Further details about compositions including a phase-separated amine can be found in Int. Pat. App. Pub. No. WO2018/085546 (Zook et al.). The curable sealant may also include a second amine that is not phase separated, such as any of those described above, and an amine that is phase-separated.

While the first amine is photochemically generated from a photolatent base, the first and second amines themselves are generally not considered photolatent bases. That is, they do not undergo photochemical reactions that generate an amine by photocleavage, photoelimination, or another mechanism.

In some embodiments of the method according to present disclosure, the method includes exposing the curable sealant composition to actinic radiation to cure the curable sealant composition. In some of these embodiments, useful photoinitiators and photolatent bases absorb light in a wavelength range from 200 nm to 650 nm. For some applications, curable sealant compositions that include a photoinitiator or photolatent base absorb light in the ultraviolet A (UVA) and/or blue light regions, for example, in a wavelength range from 315 nm to 550 nm or 315 nm to 500 nm. UVA light can be considered to have a wavelength range of 315 nm to 400 nm, and blue light can be considered to have a wavelength range of 400 nm to 495 nm or 450 nm to 495 nm.

In some embodiments in which the method includes exposing the curable sealant composition to actinic radiation, the curable sealant composition further includes at least one photosensitizer. A photosensitizer can be useful, for example, if the photoinitiator or photolatent base does not have a strong absorbance in a wavelength range that is desired for curing the curable sealant. As used herein, a photosensitizer may be understood to be, for example, a compound having an absorption spectrum that overlaps or closely matches the emission spectrum of the radiation source to be used and that can improve the overall quantum yield by means of, for example, energy transfer or electron transfer to other component(s) of the curable sealant or solution (e.g., the photoinitiator or photolatent base). Useful photosensitizers include aromatic ketones (e.g., substituted or unsubstituted benzophenones, substituted or unsubstituted thioxanthones, substituted or unsubstituted anthraquinones, and combinations thereof), dyes (e.g., oxazines, acridines, phenazines, rhodamines, and combinations thereof), 3-acylcoumarins (e.g., substituted and unsubstituted 3-benzoylcoumarins and substituted and unsubstituted 3-naphthoylcoumarins, and combinations thereof), anthracenes (e.g., substituted and unsubstituted anthracenes), 3-(2-benzothiazolyl)-7-(diethylamino)coumarin (coumarin 6), 10-acetyl-2,3,6,7-tetrahydro-1H,5H,11H-[1]benzopyrano[6,7,8-ij]quinolizin-11-one (coumarin 521), other carbonyl compounds (e.g., camphorquinone, 4-phenylacetophenone, benzil, and xanthone, and combinations thereof), and combinations thereof. In some embodiments, the photosensitizer has an absorbance in the blue light range. In some embodiments, the photosensitizer is camphorquinone. In some embodiments, coumarin photosensitizers that are triplet photosensitizers with a wavelength of maximum absorbance, λₘₐₓ, between 390 to 510 nm are used in combination with camphorquinone. Examples of such coumarin photosensitizers include 3,3′-carbonylbis(5,7-dimethoxycoumarin), 3-benzoyl-7-diethylaminocoumarin, 7-diethylamino-3-thenoylcoumarin, 3-(2-benzofuroyl)-7-diethylaminocoumarin, 7-diethylamino-5′,7′-dimethoxy-3,3′-carbonylbiscoumarin, 3,3′-carbonylbis(7-diethylaminocoumarin), 9-(7-diethylamino-3-coumarinoyl)-1,2,4,5-tetrahydro-3H,6H,10H[1]benzopyrano[9,9a,1-gh]quinolazine-10-one, and 9,9′-carbonylbis(1,2,4,5-tetrahydro-3H,6H,10H[1]benzopyrano[9,9a,1-gh]quinolazine-10-one). Further details about compositions including a photolatent base, camphorquinone, and such coumarins can be found in Int. Pat. App. Pub. No. WO2018/085534 (Clough et al.). The amount of photosensitizer can vary widely, depending upon, for example, its nature, the nature of other component(s) of the photoactivatable composition, and the particular curing conditions. When the photosensitizer is present in the curable sealant, amounts ranging from about 0.1 weight percent to about 15 weight percent can be useful. In some embodiments, the photosensitizer is included in the curable sealant in an amount from 0.5 percent to 10 percent by weight, 0.5 percent to 7.5 percent by weight, or 1 percent to 7.5 percent by weight, based on the total weight of the curable sealant composition.

In embodiments of the method of the present disclosure in which the curable sealant composition includes a photolatent base, the method can further include exposing the curable sealant composition to actinic radiation to cure the curable sealant composition. Exposing the curable sealant composition to actinic radiation can be carried out, for example, as described below. Curing the curable sealant composition in this manner can be quite rapid, and the rapidity of these reactions results in the swift gelling. Once gelation occurs, however, the mobility of small molecules within the sealant is inhibited, which can hinder the development of adequate adhesion between the sealant and the substrate. Therefore, the compositions of the present disclosure include a first amino-functional silane (in some embodiments, a polyamino-functional silane) and a second amino-functional silane) may be particularly advantageous when the curable sealant composition includes a photolatent base and/or when the method includes exposing the curable sealant composition to actinic radiation.

In some embodiments, the method of applying a sealant to a substrate according to the present disclosure includes exposing the composition disclosed herein in any of its embodiments to actinic radiation to at least partially cure at least the surface of the composition. Sources of ultraviolet and/or visible light can be useful for actinic radiation (for example, wavelengths ranging from about 200 nm to about 650 nm, from about 315 nm to 550 nm, or from about 315 nm to 500 nm can be useful). The light source and exposure time can be selected, for example, based on the nature and amount of the composition. Suitable light includes sunlight and light from artificial sources, including both point sources and flat radiators. In some embodiments, the light source is a source of at least one of UVA or blue light. In some embodiments, the light source is a blue light source.

Examples of useful light sources include carbon arc lamps; xenon arc lamps; medium-pressure, high-pressure, and low-pressure mercury lamps, doped if desired with metal halides (metal halogen lamps); microwave-stimulated metal vapor lamps; excimer lamps; superactinic fluorescent tubes; fluorescent lamps; incandescent filament lamps, incandescent argon lamps; electronic flashlights; xenon flashlights; photographic flood lamps; light-emitting diodes; laser light sources (for example, excimer lasers); and combinations thereof. The distance between the light source and the substrate can vary widely, depending upon the particular application and the type and/or power of the light source. For example, distances up to about 150 cm, distances from about 0.01 cm to 150 cm, or a distance as close as possible without touching the composition can be useful.

In some embodiments, the curable sealant composition comprises at least one of an oxygen-activated curing agent or a moisture-activated curing agent. In some embodiments, the curable sealant composition comprises an oxygen-activated curing agent. For example, polythiols as described above in any of their embodiments can be combined with a thiuram disulfide in conjunction with a member selected from the group consisting of an iron salt, iron oxide, iron hydroxide, iron metal complex, manganese salt, manganous oxide, manganese hydroxide, and manganese metal complex. For example, polythiols as described above in any of their embodiments can be combined with a dithiocarbamate selected from the group consisting of iron dithiocarbamate and manganese dithiocarbamate. A non-tacky skin can be formed on such compositions by exposure to an environment containing oxygen, and a portion of the curable sealant not exposed to oxygen (e.g., adjacent the surface of the aircraft component) will take longer to cure. Further information regarding such oxygen-activated curing agents can be found, for example, in U.S. Pat. No. 3,991,039 (Gunter).

In some embodiments, the curable sealant composition comprises a moisture-activated curing agent. For example, polysulfides as described above in any of their embodiments can be combined with an oxidizing agent such as dinitrobenzene, alkali metal peroxides (e.g., sodium peroxide), alkali metal salt peroxides (e.g., sodium pyrophosphate peroxide, sodium carbonate peroxide, sodium perborate), alkaline earth metal peroxides (e.g., calcium peroxide and barium peroxide) and other metal peroxides (e.g., zinc peroxide manganese dioxide), and ammonium dichromate, and an alkaline desiccating deliquescent accelerating agent adapted and sufficient to maintain said polymer in dry condition during shipment and storage and to attract and absorb moisture from its surroundings after deposition in place to hasten the curing of said polymer by said curing agent. Such alkaline desiccating deliquescent accelerating agents include sodium oxide, sodium peroxide, potassium hydroxide, sodium hydroxide, sodium acetate, sodium carbonate, sodium phosphate, sodium molybdate, calcium oxide, barium oxide, calcium peroxide, barium peroxide, calcium hydroxide, and strontium hydroxide. A non-tacky skin can be formed on such compositions by exposure to an environment containing moisture, and a portion of the curable sealant not exposed to moisture (e.g., adjacent the surface of the aircraft component) will take longer to cure. Further information regarding such moisture-activated curing agents can be found, for example, in U.S. Pat. No. 3,225,017 (Seegman). Any of the oxidizing agents described above can also be used in combination with molecular sieves and a cure accelerator selected from monomeric and polymeric acrylated liquid polysulfide compounds having an acrylate functionality of at least 2 to cure a mercaptan-terminated liquid polysulfide. A non-tacky skin can be formed on such compositions by exposure to an environment containing moisture. Further details regarding such moisture-activated curing agents can be found, for example, in U.S. Pat. No. 5,409,985 (Robinson).

In some embodiments, curable sealant compositions useful for practicing the method of the present disclosure include at least one oxidizing agent. Oxidizing agents can be useful, for example, when the curable sealant includes a polysulfide oligomer or polymer. In some embodiments, oxidizing agents can minimize the degradation or interchanging of disulfide bonds in the sealant network. In other embodiments, oxidizing agents can be a component for curing the curable sealant. Useful oxidizing agents include a variety of organic and inorganic oxidizing agents (e.g., organic peroxides and metal oxides). Examples of metal oxides useful as oxidizing agents include calcium dioxide, manganese dioxide, zinc dioxide, lead dioxide, lithium peroxide, and sodium perborate hydrate. Other useful inorganic oxidizing agents include sodium dichromate. Examples of organic peroxides useful as oxidizing agents include those described above. Other useful organic oxidizing agents include para-quinone dioxime.

Curable sealant compositions useful for practicing the method of the present disclosure can include rapid curing chemistries other than the thiol chemistries described above. Such rapid-curing compositions include Diels-Alder compositions and copper-catalyzed alkene-azide cycloaddition (CuAAC) compositions. Diels-Alder (DA) reactions typically involve the formation of a stable six membered ring via a [4+2] cycloaddition reaction. Most useful reactions include an electron-rich diene and an electron-poor dienophile as the reacting species and may optionally include a Lewis acid catalyst. Combining Diels-Alder end-group reactions with other polymerization processes can be a useful methodology for synthesizing functional polymers with unique architectures. Reacting alkenes and alkynes with azides to produce five membered rings is a commercially desirable process but requires high temperatures and often results in undesirable mixtures of regioisomers. Adding small quantities of Cu(I) metal dramatically lowers the reaction temperature and allows for quantitative yields of the desired product. These copper-catalyzed alkene-azide cycloaddition (CuAAC) reactions are the most common use of this chemistry today.

Curable sealant compositions in any of their embodiments described above, which are useful for practicing the method of the present disclosure, can also contain fillers. Conventional inorganic fillers such as silica (e.g., fumed silica), calcium carbonate, aluminum silicate, and carbon black may be useful as well as low density fillers. In some embodiments, the curable sealant disclosed herein includes at least one of silica, hollow ceramic elements, hollow polymeric elements, calcium silicates, calcium carbonate, or carbon black. Silica, for example, can be of any desired size, including particles having an average size above 1 micrometer, between 100 nanometers and 1 micrometer, and below 100 nanometers. Silica can include nanosilica and amorphous fumed silica, for example. Suitable low density fillers may have a specific gravity ranging from about 1.0 to about 2.2 and are exemplified by calcium silicates, fumed silica, precipitated silica, and polyethylene. Examples include calcium silicate having a specific gravity of from 2.1 to 2.2 and a particle size of from 3 to 4 microns (“HUBERSORB HS-600”, J. M. Huber Corp.) and fumed silica having a specific gravity of 1.7 to 1.8 with a particle size less than 1 (“CAB-O-SIL TS-720”, Cabot Corp.). Other examples include precipitated silica having a specific gravity of from 2 to 2.1 (“HI-SIL TS-7000”, PPG Industries), and polyethylene having a specific gravity of from 1 to 1.1 and a particle size of from 10 to 20 microns (“SHAMROCK S-395” Shamrock Technologies Inc.). The term “ceramic” refers to glasses, crystalline ceramics, glass-ceramics, and combinations thereof. Hollow ceramic elements can include hollow spheres and spheroids. The hollow ceramic elements and hollow polymeric elements may have one of a variety of useful sizes but typically have a maximum dimension of less than 10 millimeters (mm), more typically less than one mm. The specific gravities of the microspheres range from about 0.1 to 0.7 and are exemplified by polystyrene foam, microspheres of polyacrylates and polyolefins, and silica microspheres having particle sizes ranging from 5 to 100 microns and a specific gravity of 0.25 (“ECCOSPHERES”, W. R. Grace & Co.). Other examples include elastomeric particles available, for example, from Akzo Nobel, Amsterdam, The Netherlands, under the trade designation “EXPANCEL”. Other examples include alumina/silica microspheres having particle sizes in the range of 5 to 300 microns and a specific gravity of 0.7 (“FILLITE”, Pluess-Stauffer International), aluminum silicate microspheres having a specific gravity of from about 0.45 to about 0.7 (“Z-LIGHT”), and calcium carbonate-coated polyvinylidene copolymer microspheres having a specific gravity of 0.13 (“DUALITE 6001AE”, Pierce & Stevens Corp.). Further examples of commercially available materials suitable for use as hollow, ceramic elements include glass bubbles marketed by 3M Company, Saint Paul, Minn., as “3M GLASS BUBBLES” in grades K1, K15, K20, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”; glass bubbles marketed by Potters Industries, Carlstadt, N.J., under the trade designations “Q-CEL HOLLOW SPHERES” (e.g., grades 30, 6014, 6019, 6028, 6036, 6042, 6048, 5019, 5023, and 5028); and hollow glass particles marketed by Silbrico Corp., Hodgkins, Ill. under the trade designation “SIL-CELL” (e.g., grades SIL 35/34, SIL-32, SIL-42, and SIL-43). Such fillers, alone or in combination, can be present in a sealant in a range from 10 percent by weight to 55 percent by weight, in some embodiments, 20 percent by weight to 50 percent by weight, based on the total weight of the curable sealant composition. The presence of filler in the curable sealant provides the advantageous effect of increasing the open time of the curable sealant in some cases.

Other fillers useful in the curable sealant compositions are special purpose fillers. Such fillers are used to impart properties such as fire resistance. Examples of suitable fillers providing fire resistance include aluminum trihydroxide (ATH) and magnesium dihydroxide.

Curable sealant compositions in any of their embodiments described above, which are useful for practicing the method of the present disclosure, can also contain at least one of cure accelerators, colorants (e.g., pigments and dyes), thixotropic agents, and solvents. The solvent can conveniently be any material (e.g., N-methyl-2-pyrrolidone, tetrahydrofuran, ethyl acetate, or those described below) capable of dissolving a component of the curable sealant. Suitable pigments and dyes can include those that do not absorb in the wavelength range that is desirable for curing the composition. Examples of pigments and dyes useful in the compositions according to the present disclosure can be found in Int. Pat. App. Pub. No. W02018/085190 (Townsend et al.).

Curable sealant compositions in any of their embodiments described above, which are useful for practicing the method of the present disclosure, can also contain adhesion promoters. In some embodiments, useful adhesion promoters include organosilanes have amino functional groups (e.g., N-2-(aminoethyl)-3-aminopropyltrimethoxysilane and (3-aminopropyl)trimethoxysilane) and any of the amino-functional silanes described above. In some embodiments, useful adhesion promoters have groups polymerizable by, for example, actinic radiation. Examples of polymerizable moieties are materials that contain olefinic functionality such as styrenic, vinyl (e.g., vinyltriethoxysilane, vinyltri(2-methoxyethoxy) silane), acrylic and methacrylic moieties (e.g., 3-metacrylroxypropyltrimethoxysilane). Some functional silanes useful as adhesion promoters are commercially available, for example, from Momentive Performance Materials, Inc., Waterford, N.Y., under the trade designations “SILQUEST A-187” and “SILQUEST A-1100”.

Curable sealant compositions in any of their embodiments described above, which are useful for practicing the method of the present disclosure, can also contain wetting agents. Examples of suitable wetting agents include a silicone, modified silicone, silicone acrylate, hydrocarbon solvent, fluorine-containing compound, non-silicone polymer or copolymer such as a copolyacrylate, and mixtures thereof. Examples of nonionic surfactants suitable as wetting agents in the curable sealants disclosed herein include block copolymers of polyethylene glycol and polypropylene glycol, polyoxyethylene (7) lauryl ether, polyoxyethylene (9) lauryl ether, polyoxyethylene (18) lauryl ether, and polyethoxylated alkyl alcohols such as those available, for example, from Air Products and Chemicals Inc., Allentown, Pa., under the trade designation “SURFYNOL SE-F”. Fluorochemical surfactants such as those available under the trade designation “FLUORAD” from 3M Company of St. Paul, Minn.) may also be useful. In some embodiments, the curable sealant useful for practicing the present disclosure includes at least about 0.001 wt %, at least about 0.01 wt %, or at least about 0.02 wt % of at least one wetting agent and up to about 2 wt %, up to about 1.5 wt %, or up to about 1 wt % of at least one wetting agent.

Curable sealant compositions in any of their embodiments described above, which are useful for practicing the method of the present disclosure, can be packaged either as two-part products or one-part products. For the two-part products including a curable composition that can at least partially cure at room temperature, once the user mixes the two parts, the reaction begins, and the sealant starts to form into an elastomeric solid. After mixing, the time that the sealant remains usable is called the application life or open time. Throughout the application life, viscosity of the sealant gradually increases until the sealant is too viscous to be applied. In practice, users choose products with differing application lives and cure times depending on the specific application. For one-part products that can at least partially cure at room temperature, users can avoid a complicated mixing step, but the product is typically shipped and stored in a freezer before application. One-part products that are cured by actinic radiation (e.g., that do not include a second initiator for curing at room temperature or elevated temperature, may be able to be shipped and stored at room temperature before application.

In some embodiments, cured sealants prepared from the method according to the present disclosure may be useful in these applications, for example, because of their fuel resistance and low glass transition temperatures. In some embodiments, the cured sealant prepared according to the present disclosure has a low glass transition temperature, in some embodiments less than −20° C., in some embodiments less than −30° C., in some embodiments less than −40° C., and in some embodiments less than −50° C. In some embodiment, the cured sealant prepared according to the present disclosure has high jet fuel resistance, characterized by a volume swell of less than 30% and a weight gain of less than 20% when measured according to Society of Automotive Engineers (SAE) International Standard AS5127/1.

As shown in the Examples, below, compositions of the present disclosure provide excellent adhesion to aluminum, steel, and epoxy coated aluminum before and after immersion in jet fuel or salt water. Nearly every Example provided peel strengths of at least 20 lbs/inch (3.57 kg/cm) even after immersion in jet fuel or salt water for 168 hours. Only Example 1 when used on stainless steel and after immersion in jet fuel for 168 hours at 60° C. provided a peel strength of less than 20 lbs/inch (3.57 kg/cm): 19 lbs/inch (3.39 kg/cm). Furthermore, all Examples displayed strong fluorescence when exposed to 455 nm light. Advantageously, after application to a substrate surface, inspection using 455-nm light will readily indicate where the composition was applied.

Some embodiments of the composition of the present disclosure unexpectedly provided a higher level of cohesive failure in the sealant than others. Cohesive failure in the sealant is desirable over adhesive failure at the substrate. Examples 5 and 6 provided no adhesive failures under any of the conditions evaluated. Examples 5 and 6 included a polyamino-functional silane and a second polyamino-functional silane, the second polyamino-functional silane including two independently selected silane groups. The polyamino-functional silane also provided advantageous cohesive failures to other compositions in comparison to (3-aminopropyl)trimethoxysilane. For example, Examples 2 and 3 provided more cohesive failure after immersion in jet fuel or salt water than Example 1.

### Some Embodiments of the Disclosure

In a first embodiment, the present disclosure provides a composition comprising:

a first amino-functional silane comprising an amino group and a silane group, wherein the amino group and the silane group are connected by an organic linking group;

a second amino-functional silane comprising a secondary or tertiary amino group and least two independently selected silane groups, wherein the secondary or tertiary amino group is connected to each of the two independently selected silane groups by organic linking groups; and

a photoluminescent compound exhibiting photoluminescence at an excitation wavelength above 400 nanometers.

In a second embodiment, the present disclosure provides the composition of the first embodiment, wherein the composition further comprises water.

In a third embodiment, the present disclosure provides the composition of the first or second embodiment, wherein the composition further comprises organic solvent.

In a fourth embodiment, the present disclosure provides the composition of any one of the first to third embodiments, wherein first amino-functional silane is represented by formula:

((R³)₂N—[R¹—Z]ₙ—R¹-[Si(Y)ₚ(R²)₃₋ₚ]

wherein

each R¹ is independently alkylene, arylene, or alkylene interrupted or terminated by arylene;

R² is alkyl, aryl, or alkylenyl interrupted or terminated by aryl;

each Z is independently —O— or —N(R³)—;

each R³ is independently hydrogen, alkyl, aryl, or arylalkylenyl;

Y is alkoxy, acetoxy, aryloxy, or halogen;

n is 0, 1, 2, or 3; and

p is 1, 2, or 3.

In a fifth embodiment, the present disclosure provides the composition of the fourth embodiment, wherein each R³ is hydrogen, wherein each R¹ is independently alkylene, and wherein n is 1, 2, or 3.

In a sixth embodiment, the present disclosure provides the composition of any one of the first to fifth embodiments, wherein the second amino-functional silane is represented by formula:

(R⁶)₂N—[R⁴—Z′],—R⁴—[Si(Y)ₚ(R⁵)₃₋ₚ]

wherein

R⁴ is arylene or alkylene optionally interrupted or terminated by arylene;

each Z′ is independently —O— or —NR⁶—;

R⁵ is alkyl, aryl, or alkylenyl interrupted or terminated by aryl;

each R⁶ is independently hydrogen, alkyl, aryl, arylalkylenyl, or —R⁴—[Si(Y)ₚ(R⁵)₃₋ₚ];

each Y is independently hydroxyl, alkoxy, acetoxy, aryloxy, or halogen;

r is 0, 1, 2, or 3; and

p is 1, 2, or 3;

with the proviso that at least two independently selected —Si(Y)ₚ(R⁵)₃₋ₚ groups are present.

In a seventh embodiment, the present disclosure provides the composition of the sixth embodiment, wherein each R⁴ is independently alkylene, and r is 1, 2, or 3.

In an eighth embodiment, the present disclosure provides the composition of any one of the first to seventh embodiments, wherein the first amino-functional silane is [3-(2-aminoethylamino)propyl]trimethoxysilane, 3-[2-(2-aminoethylamino)ethylamino]propyltrimethoxysilane, or a combination thereof, and wherein the second amino-functional silane is N,N′-bis[3-trimethoxysilylpropyl]-ethylenediamine, N,N-bis[3-trimethoxysilylpropyl]-ethylenediamine, or a combination thereof.

In a ninth embodiment, the present disclosure provides the composition of any one of the first to eighth embodiments, wherein the first amino-functional silane and the second amino-functional silane together make up at least 70 percent of silane compounds in the composition.

In a tenth embodiment, the present disclosure provides the composition of any one of the first to ninth embodiments, wherein the first amino-functional silane and the second amino-functional silane together make up at least 70 percent of solids (excluding water and organic solvent) in the composition.

In an eleventh embodiment, the present disclosure provides a composition comprising:

a polyamino-functional silane comprising at least two amino groups and a silane group, wherein at least one of the amino groups and the silane group are connected by an organic linking group; and

a second amino-functional silane comprising a secondary or tertiary amino group and least two independently selected silane groups, wherein the secondary or tertiary amino group is connected to each of the two independently selected silane groups by organic linking groups.

In a twelfth embodiment, the present disclosure provides the composition of the eleventh embodiment, wherein the composition further comprises water.

In a thirteenth embodiment, the present disclosure provides the composition of the eleventh or twelfth embodiment, wherein the composition further comprises organic solvent.

In a fourteenth embodiment, the present disclosure provides the composition of any one of the eleventh to thirteenth embodiments, wherein the polyamino-functional silane and the second amino-functional silane together make up at least 70 percent of silane compounds in the composition.

In a fifteenth embodiment, the present disclosure provides the composition of any one of the eleventh to fourteenth embodiments wherein the polyamino-functional silane and the second amino-functional silane together make up at least 70 percent of solids (excluding organic solvent and water) in the composition.

In a sixteenth embodiment, the present disclosure provides the composition of any one of the eleventh to fifteenth embodiments, wherein the polyamino-functional silane is represented by formula:

(R⁹)₂N—[R⁷—N(H)]ₘ—R⁷—Si(Y)ₚ(R⁸)₃₋ₚ]

wherein

each R⁷ is independently alkylene;

R⁸ is alkyl, aryl, or alkylenyl interrupted or terminated by aryl;

each R⁹ is independently hydrogen, alkyl, or arylalkylenyl;

each Y is independently hydroxyl, alkoxy, acetoxy, aryloxy, or halogen;

m is 1, 2, or 3; and

p is 1, 2, or 3.

In a seventeenth embodiment, the present disclosure provides the composition of the sixteenth embodiment, wherein each R⁹ is hydrogen.

In an eighteenth embodiment, the present disclosure provides the composition of any one of the eleventh to seventeenth embodiments, wherein the second amino-functional silane is represented by formula:

(R⁶)₂N—[R⁴—Z′]ᵣ—R⁴—[Si(Y)ₚ(R⁵)₃₋ₚ]

wherein

R⁴ is arylene or alkylene optionally interrupted or terminated by arylene;

each Z′ is independently —O— or —NR⁶—;

R⁵ is alkyl, aryl, or alkylenyl interrupted or terminated by aryl;

each R⁶ is independently hydrogen, alkyl, aryl, arylalkylenyl, or —R⁴—[Si(Y)ₚ(R⁵)₃₋ₚ];

each Y is hydroxyl, alkoxy, acetoxy, aryloxy, or halogen;

r is 0, 1, 2, or 3; and

p is 1, 2, or 3;

with the proviso that at least two independently selected —Si(Y)ₚ(R⁵)₃₋ₚ groups are present.

In a nineteenth embodiment, the present disclosure provides the composition of the eighteenth embodiment, wherein each R⁴ is independently alkylene, and r is 1, 2, or 3.

In a twentieth embodiment, the present disclosure provides the composition of any one of the eleventh to nineteenth embodiments, wherein the second amino-functional silane is a second polyamino-functional silane comprising the secondary or tertiary amino group, at least one other amino group, and the at least two independently selected silane groups.

In a twenty-first embodiment, the present disclosure provides the composition of any one of the eleventh to twentieth embodiments, wherein the polyamino-functional silane is [3-(2-aminoethylamino)propyl]trimethoxysilane, 3-[2-(2-aminoethylamino)ethylamino]propyltrimethoxysilane, or a combination thereof, and wherein the second amino-functional silane is N,N′-bis[3-trimethoxysilylpropyl]-ethylenediamine, N,N-bis[3-trimethoxysilylpropyl]-ethylenediamine, or a combination thereof.

In a twenty-second embodiment, the present disclosure provides the composition of any one of eleventh to twenty-first embodiments, further comprising a photoluminescent compound.

In a twenty-third embodiment, the present disclosure provides the composition of the twenty-second embodiment, wherein the photoluminescent compound exhibits photoluminescence at an excitation wavelength above 400 nanometers.

In a twenty-fourth embodiment, the present disclosure provides the composition of any one of the first to tenth, twenty-second, or twenty-third embodiments, wherein the photoluminescent compound is [9-(2-carboxyphenyl)-6-diethylamino-3-xanthenylidene]-diethylammonium chloride, 9-[2-(ethoxycarbonyl)phenyl]-3,6-bis(ethylamino)-2,7-dimethylxanthylium chloride (1:1), 6-amino-9-(2-methoxycarbonylphenyl)xanthen-3-ylidene]azanium chloride, 3′,6′-dihydroxyspiro[isobenzofuran-1(3H),9′-[9H]xanthen]-3-one, or a combination thereof.

In a twenty-fifth embodiment, the present disclosure provides use of the composition of any one of the first to twenty-fourth embodiment as an adhesion promoter for a sealant on an aircraft component.

In a twenty-sixth embodiment, the present disclosure provides an aircraft component treated with the composition of any one of the first to twenty-fourth embodiments.

In a twenty-seventh embodiment, the present disclosure provides the use or aircraft component of the twenty-fifth or twenty-sixth embodiment, wherein the aircraft component comprises at least one of a seam or joint between portions of aircraft skin.

In a twenty-eighth embodiment, the present disclosure provides the use or aircraft component of the twenty-fifth or twenty-sixth embodiment, wherein the aircraft component comprises at least one of an aircraft fastener, an aircraft window, an aircraft access panel, a fuselage protrusion, or an aircraft fuel tank.

In a twenty-ninth embodiment, the present disclosure provides a method of applying a sealant to a substrate, the method comprising:

applying the composition of any one of the first to twenty-fourth embodiments to a surface of the substrate to provide a primed surface; and

subsequently applying a curable sealant composition on the primed surface.

In a thirtieth embodiment, the present disclosure provides the method of the twenty-ninth embodiment, wherein the curable sealant composition comprises a polythiol comprising more than one thiol group.

In a thirty-first embodiment, the present disclosure provides the method of the thirtieth embodiment, wherein the polythiol is monomeric.

In a thirty-second embodiment, the present disclosure provides the method of the thirtieth embodiment, wherein the polythiol is oligomeric or polymeric.

In a thirty-third embodiment, the present disclosure provides the method of the thirty-second embodiment, wherein the polythiol is a polythioether.

In a thirty-fourth embodiment, the present disclosure provides the method of the thirty-third embodiment, wherein the polythiol is an oligomer or polymer prepared from components comprising a dithiol and a diene or divinyl ether.

In a thirty-fifth embodiment, the present disclosure provides the method of the thirty-second embodiment, wherein the polythiol is a polysulfide oligomer or polymer.

In a thirty-sixth embodiment, the present disclosure provides the method of the thirty-fifth embodiment, wherein the curable sealant further comprises an oxidizing agent.

In a thirty-seventh embodiment, the present disclosure provides the method of the thirtieth to thirty-sixth embodiments, wherein the curable sealant comprises a polyepoxide comprising more than one epoxide group.

In a thirty-eighth embodiment, the present disclosure provides the method of the thirty-seventh embodiment, wherein the polyepoxide is monomeric.

In a thirty-ninth embodiment, the present disclosure provides the method of the thirty-seventh embodiment, wherein the polyepoxide is oligomeric or polymeric.

In a fortieth embodiment, the present disclosure provides the method of any one of the thirty-seventh to thirty-ninth embodiments, wherein the polyepoxide is aromatic.

In a forty-first embodiment, the present disclosure provides the method of any one of the thirty-seventh to thirty-ninth embodiments, wherein the polyepoxide is non-aromatic.

In a forty-second embodiment, the present disclosure provides the method of any one of the thirty-seventh to forty-first embodiments, wherein the polyepoxide comprises three or more epoxide groups.

In a forty-third embodiment, the present disclosure provides the method of any one of the thirtieth to thirty-sixth embodiments, wherein the curable sealant comprises a Michael acceptor comprising more than one Michael acceptor group.

In a forty-fourth embodiment, the present disclosure provides the method of any one of the thirtieth to forty-third embodiments, wherein the curable sealant further comprises a photolatent base catalyst.

In a forty-fifth embodiment, the present disclosure provides the method of the forty-fourth embodiment, further comprising exposing the curable sealant composition to actinic radiation to cure the curable sealant composition.

In a forty-sixth embodiment, the present disclosure provides the method of the forty-fourth or forty-fifth embodiment, wherein the photolatent base catalyst generates a first amine upon exposure to actinic radiation.

In a forty-seventh embodiment, the present disclosure provides the method of the forty-sixth embodiment, wherein the first amine comprises at least one of a tertiary amine, an amidine, or a guanidine.

In a forty-eighth embodiment, the present disclosure provides the method of any one of the forty-fourth to forty-seventh embodiments, wherein the curable sealant composition further comprises a catalytic amount of a second amine, which may be the same or different from the first amine.

In a forty-ninth embodiment, the present disclosure provides the method of the forty-eighth embodiment, wherein at least one of the first amine or second amine is triethylamine, dimethylethanolamine, benzyldimethylamine, dimethylaniline, tribenzylamine, triphenylamine, tetramethylguanidine (TMG), 1,8-diazabicyclo[5.4.0]undec-7-ene (DBU), 1,5-diazabicyclo[4.3.0]non-5-ene (DBN), 1,4-diazabicyclo[2.2.2]octane (DABCO), quinuclidine, diphenylguanidine (DPG), dimethylaminomethyl phenol, and tris(dimethylaminomethyl)phenol.

In a fiftieth embodiment, the present disclosure provides the method of any one of the forty-fifth to forty-ninth embodiments, wherein the actinic radiation comprises blue light.

In a fifty-first embodiment, the present disclosure provides the method of any one of the thirtieth to thirty-sixth embodiments, wherein the curable sealant composition further comprises at least one unsaturated compound comprising more than one carbon-carbon double bond, at least one carbon-carbon triple bond, or a combination thereof.

In a fifty-second embodiment, the present disclosure provides the method of the fifty-first embodiment, wherein the at least one unsaturated compound comprises two carbon-carbon double bonds, and wherein the curable composition further comprises a second unsaturated compound comprising three carbon-carbon double bonds.

In a fifty-third embodiment, the present disclosure provides the method of the fifty-first or fifty-second embodiment, wherein the curable sealant further comprises a free-radical photoinitiator.

In a fifty-fourth embodiment, the present disclosure provides the method of any one of the fifty-first to fifty-third embodiments, wherein the method further comprises exposing the curable sealant composition to actinic radiation to cure the curable sealant composition.

In a fifty-fifth embodiment, the present disclosure provides the method of the fifty-fourth embodiment, wherein the actinic radiation comprises blue light.

In a fifty-sixth embodiment, the present disclosure provides the method of any one of the fifty-first to fifty-fifth embodiments, wherein the curable sealant composition further comprises an organic peroxide.

In a fifty-seventh embodiment, the present disclosure provides the method of the fifty-sixth embodiment, wherein the curable sealant composition further comprises an organoborane-amine complex.

In a fifty-eighth embodiment, the present disclosure provides the method of the fifty-sixth embodiment, wherein the curable sealant composition further comprises an amine.

In a fifty-ninth embodiment, the present disclosure provides the method of any one of the thirtieth to thirty-sixth embodiments, wherein the curable sealant composition comprises at least one of an oxygen-activated curing agent or a moisture-activated curing agent.

In a sixtieth embodiment, the present disclosure provides the method of any one of the twenty-ninth to fifty-ninth embodiments, wherein the substrate comprises an aircraft component.

In a sixty-first embodiment, the present disclosure provides the method of any one of the twenty-ninth to sixtieth embodiments, wherein the curable sealant composition is applied to at least one of a seam or joint between portions of aircraft skin.

In a sixty-second embodiment, the present disclosure provides the method of any one of the twenty-ninth to sixty-first embodiments, wherein the curable sealant composition is applied to at least one of an aircraft fastener, an aircraft window, an aircraft access panel, a fuselage protrusion, or an aircraft fuel tank.

In a sixty-third embodiment, the present disclosure provides the method of any one of the twenty-ninth to sixty-second embodiments, wherein applying the curable sealant composition takes place within 6 hours, 4 hours, or 2 hours after applying the composition to provide the primed surface.

In a sixty-fourth embodiment, the present disclosure provides the method of any one of the twenty-ninth to sixty-third embodiments, further comprising inspecting the primed surface by exposing the primed surface to blue light before applying the curable sealant composition.

In a sixty-fifth embodiment, the present disclosure provides the method of any one of the twenty-ninth to sixty-fourth embodiments, wherein the curable sealant composition further comprises a fire-resistant filler.

In a sixty-sixth embodiment, the present disclosure provides an aircraft comprising the aircraft component of the twenty-eighth or twenty-ninth or made by the method of any one of the sixtieth to sixty-fifth embodiments.

In order that this disclosure can be more fully understood, the following examples are set forth. It should be understood that these examples are for illustrative purposes only and are not to be construed as limiting this disclosure in any manner.

### EXAMPLES

Unless otherwise noted, all reagents were obtained or are available from Sigma-Aldrich Company, St. Louis, Mo., or may be synthesized by known methods. Unless otherwise reported, all ratios are by weight percent.

TABLE 1
Materials

| Designation | Description | Source |
|---|---|---|
| 3AEAEAPTMS | 3-[2-(2- | Gelest, Inc. of Morrisville, |
| | aminoethylamino)ethylamino]propyltrimetlioxysilane | PA, USA |
| 3AEAPTMS | [3-(2-aminoethylamino)propyl]trimethoxysilane | Gelest, Inc. |
| 3APTMS | (3-aminopropyl)trimethoxysilane | Gelest, Inc. |
| A1100 | Silquest A-1100, gamma-aminopropyltriethoxysilane | Momentive Performance |
| | | Materials of Waterford, |
| | | NY, USA |
| AMS2629E | Jet reference fluid Type I | AFRL/RQTF of Wright- |
| | | Patterson AFB, OH, USA |
| BTMSPA | Bis(trimethoxysilylpropyl)amine | Gelest, Inc. |
| BTMSPED | N,N′-bis[(3-tnmethoxysilyl)propyl]ethylenediamine, | Shin Etsu Silicones of |
| | also contains N,N-bis[(3- | America of Akron, OH, |
| | trimethoxysilyl)propyl]ethylenediamine | USA |
| D-E135 | Expanding polymeric microsphere available under the | Chase Corporation of |
| | trade designation “DUALITE E135-040D” | Westwood, MA, USA |
| DABCO 33LV | 1,4-diazabicyclo[2.2.2]octane 33% solution in | Evonik of Essen, Germany |
| | dipropylene glycol; | |
| DAEBPA | Diallyl ether of bisphenol A | Bimax of Glen Rock, PA, |
| | | USA |
| E200 | Koptec Pure Ethanol - 200 proof | Decon Labs of King of |
| | | Prussia, PA, USA |
| HA187 | 1:1 Hydrolyzed glycidoxypropyltrimethoxysilane | 3M Company of St. Paul, |
| | | MN, USA |
| MEK | Methyl Ethyl Ketone | Alfa Aesar of Ward Hill, |
| | | MA, USA |
| OR819 | Phenylbis(2,4,6-trimethylbenzoyl)phosphine oxide | IGM Resins of St. Charles, |
| | available under the trade designation “OMNIRAD | IL, USA |
| | 819” | |
| PCNB | PCN Blue Plasticizer Paste 11S695 | Penn Color of Doylestown, |
| | | PA, USA |
| PTE | Thiol-terminated polythioether oligomer with the | 3M Company |
| | equivalent weight of 1482 g/mol synthesized as | |
| | described in “Polythioether Example 1” in PCT Publ. | |
| | No. WO 2016/130673 | |
| R-202 | Fumed silica available under the trade designation | Evonik |
| | “AEROSIL R202” | |
| RB | Rhodamine B | TCI America of Portland, |
| | | OR, USA |
| S322 | Coated calcium carbonate available under the trade | Solvay Chemicals of |
| | designation “SOCAL 332” | Houston, TX, USA |
| TAIC | Triallyl isocyanurate | Tokyo Chemical Industry |
| | | Co. of Portland, OR, USA |
| TBEC | tert-Butylperoxy 2-ethylhexyl carbonate | Sigma-Aldrich of St. Louis, |
| | | MO, USA |
| TnBB-MOPA | Tri-n-butylborane methoxypropylamine | BASF Chemical Co. of |
| | | Ludwigshafen, Germany |
| WATER | Deionized water | 3M Company |

### Test Methods:

All test methods with the exception of the depth of cure test are based on those found in SAE International Aerospace Standard AS5127/1, Rev. C.

### Depth of Cure

A 0.635 cm (¼ in) deep cylindrical silicone rubber mold was placed on glass slides and loaded with a given sealant sample. Each molded specimen was irradiated with the Clearstone LED array (455 nm) of Hopkins, Minn. USA at 100% power from a distance of 2.54 cm (1 inch) for 30 seconds. Following this, the uncured material on the bottom side of the sample was scraped away with a spatula, leaving only a cured disc. The underside of the cured disc was quickly irradiated with the light to remove tack, and the thickness of the cured disc was measured with a 500-196-30 Digimatic Digital Caliper from Mitutoyo of Kanagawa, Japan.

### Hardness, Tensile Strength and Elongation at Break

Freshly mixed sealant was placed into an open-faced PTFE mold with cavity dimensions 9.525 cm×4.064 cm×0.318 cm (3.75 in×1.6 in×0.125 in). The excess sealant was scraped off with a flat-bladed scraper. The molded sealant sample was cured by placing under a custom Clearstone LED array (455 nm) of Hopkins, Minn. USA and irradiated at 100% power for 45 seconds.

### Hardness Measurement

The instantaneous hardness is determined in accordance with ASTM D2240 using a Model 2000 Type A Durometer from Rex Gauge Company of Buffalo Grove, IL. USA after the sealant was allowed to cure under the given conditions. The reading was taken on two 0.318 cm (0.125 in) thick specimens, stacked back to back (for a “Top Hardness” measurement) or front to front (for a “Bottom Hardness. If the thickness was less than 0.318 cm (0.125 in), then multiple pieces were stacked to obtain a total thickness of at least 0.635 cm (0.25 in).

### Tensile Strength and Elongation at Break

After curing, three tensile specimens were cut from the sheet using the small dogbone-shaped die specified in ASTM D638V. These specimens were tested in accordance with ASTM D638V using a jaw separation rate of 50.8 cm±2.54 cm per minute (20 inches±1 inch per minute). The thickness of each specimen was recorded and used to calculate the value of tensile strength.

### Peel Strength Test Panels

To prepare the peel strength test panels referenced herein, the substrates were cleaned by flooding with MEK followed by scrubbing with AMS 3819 Grade A cloth wipes. After scrubbing, the panels were again flooded with the solvent and immediately wiped dry using AMS3819 Grade A cloth wipes. The cleaned surface was allowed to dry for 15 minutes at room temperature. The adhesion promoter was then applied to the dry surface by immersing the panel for 30 seconds in an adhesion promoter bath and allowing the adhesion promoter to dry for 20 minutes prior to application of the sealant.

Peel panels were made using a cure on demand sealant. To construct the panel, a layer approximately 0.216 cm (0.085 in) thick of freshly mixed sealant was applied to about 12.7 cm (5 inches) of the panel. Two fiberglass strips, 2.54 cm (1 in) wide and 0.013 cm (0.005 in) thick, were first treated with AC-160 adhesion promoter (3M Company, St. Paul, Minn.), dried for at least 30 minutes, impregnated with the sealant and laid atop the sealant layer. The fiberglass strips were tapped gently into the sealant layer. More sealant was laid across the panel so that the total sealant thickness was about 0.318 cm (⅛ in).

After irradiation with 455 nm blue light (using a Clearstone LED array (455 nm) from Hopkins, Minn., USA at 100% power for 30 seconds), the panels were allowed to cool to ambient temperature and the fiberglass fabric strips were reinforced with polyimide tape. Approximately 2.54 cm (one inch) of one strip of sealant on each panel was pulled at 180 degrees on an MTS universal tester, in a method similar to that described in SAE AS5127/1C, at 5.08 cm per minute (2 inches per minute) to check adhesion. Adhesion was checked at 1, 5, 7, and 14 days. The panels were then placed in quart jars with approximately 900 mL of 50:50 (by volume) blend of AMS2629E Type I Jet Reference Fluid and 3% salt water. The jars were placed in a 60° C. (140° F.) water bath for 7 days. After cooling, the panels were removed one at a time and the second strip on each panel was pulled at 5.08 cm per minute (2 inches per minute) as in SAE AS5127/1C.

### Physical Property Testing of Mixed Part A and Part B Cured Sealant

### Step 1: Blending of Cure-on-Demand Sealant (Part A)

Part A was prepared by mixing the DABCO 33LV and PTE in a MAX 200 DAC cup (FlackTek, Inc. of Landrum, S.C. USA) with R-202, S322, D-E135 and TnBB-MOPA. Quantities of the ingredients (in grams) are represented in Table 2. The cup was then speed mixed for 60 seconds at 1600 RPM (SPEEDMIXER model DAC 400 FVZ from FlackTek, Inc.). The sides and bottom of the cup were scraped with a spatula and the cup speed mixed for an additional 30 seconds at 1600 RPM.

TABLE 2
Part A Composition

| Ingredient | Quantity (grams) |
|---|---|
| PTE | 147.16 |
| DABCO | 0.02 |
| R-202 | 0.74 |
| S322 | 48.56 |
| D-E135 | 2.42 |
| TnBB-MOPA | 1.10 |

### Step 2: Blending of Cure-on-Demand Sealant (Part B)

Part B was prepared by speed mixing (SPEEDMIXER model DAC 400 FVZ, FlackTek, Inc.) the ingredients, DAEBPA, TRIC, TBEC, OR819, R-202, PCNB, HA187 and D-E135 in a MAX 200 DAC cup (FlackTek, Inc.) for 60 seconds at 1600 RPM. Quantities of the ingredients (in grams) are represented in Table 3. The sides and bottom of the cup were scraped with a spatula and the cup speed mixed for an additional 30 seconds at 1600 RPM.

TABLE 3
Part B Composition

| Ingredient | Quantity (grams) |
|---|---|
| DAEBPA | 102.14 |
| TAIC | 6.52 |
| TBEC | 19.36 |
| OR819 | 8.16 |
| R-202 | 17.26 |
| PCNB | 0.08 |
| HA187 | 34.98 |
| D-E135 | 11.50 |

### Step 3: Mixing of Part A and Part B Sealant

Cured sealant was prepared by speed mixing 90.92 g of Part A and 10.34 g of Part B in a MAX 100 DAC cup for 20 seconds at 2000 RPM. The sides and bottom of the cup were scraped with a spatula and the cup speed mixed for an additional 20 seconds at 2000 RPM. The Depth of Cure was found to be 0.330 cm (0.130 in) when determined using the Depth of Cure test method described previously. Tensile strength, elongation, and hardness measurements for the mixture were then determined according to the Tensile Strength and Elongation at Break test method and the Hardness Measurement test method described previously. Light cure refers to a sample irradiated with a Clearstone LED array for 30 seconds at distance 2.54 cm (1 in) and allowed to sit for 14 days. 1+1 dark cure refers to 1 day of curing at ambient temperature, followed by 1 day of curing in a 60° C. oven. 2+4 dark cure refers to 2 days of curing at ambient temperature, followed by 4 days of curing in a 60° C. oven. Results are represented in Table 4.

TABLE 4
Test Results for Part A and Part B
Mixture at Various Cure Conditions

| | Tensile Strength | Elongation | Hardness, |
|---|---|---|---|
| Sample | kPa (psi) | at Break % | Shore A |
| light cure | 2300 ± 35 | 228 ± 8 | 50 |
| | (333 ± 5) | | |
| 1 + 1 dark cure | 2237 ± 28 | 500 ± 11 | 41 |
| | (324 ± 4) | | |
| 2 + 4 dark cure | 2452 ± 90 | 459 ± 37 | 44 |
| | (355 ± 13) | | |

### EXAMPLES 1 TO 6 (Ex. 1 to 6)

### Adhesion Promoters

Adhesion promoter compositions were prepared by combining the ingredients listed in Table 5. The mixtures were placed in an appropriately sized (i.e., 500-mL) plastic bottle, vigorously stirred for 30 minutes with a magnetic stir bar and allowed to sit for 48 hours before use. All amounts are in parts by weight. All compositions appeared dark pink in color with no turbidity, and each sample displayed strong fluorescence when exposed to 455 nm light.

TABLE 5
Examples 1 to 6 (Ex. 1 to 6)

| Component | Ex. 1 | Ex. 2 | Ex. 3 | Ex. 4 | Ex. 5 | Ex. 6 |
|---|---|---|---|---|---|---|
| 3APTMS | 0.92 | 0 | 0 | 0.92 | 0 | 0 |
| 3AEAPTMS | 0 | 1.14 | 0 | 0 | 1.14 | 0 |
| 3AEAEAPTMS | 0 | 0 | 1.37 | 0 | 0 | 1.37 |
| BTMSPA | 2.00 | 2.00 | 2.00 | 0 | 0 | 0 |
| BTMSPED | 0 | 0 | 0 | 2.25 | 2.25 | 2.25 |
| E200 | 139.73 | 139.52 | 139.31 | 139.49 | 139.28 | 139.07 |
| WATER | 7.35 | 7.34 | 7.33 | 7.34 | 7.33 | 7.32 |
| RB | 0.045 | 0.045 | 0.045 | 0.045 | 0.045 | 0.045 |

### Peel Strength Evaluation

Peel strength testing was performed for Examples 1 to 6 on bare aluminum with no immersion. Results are represented in Table 6.

TABLE 6
Peel Strength Testing - Aluminum with No Immersion

| | Ex. 1 | Ex. 2 | Ex. 3 | Ex. 4 | Ex. 5 | Ex. 6 |
|---|---|---|---|---|---|---|
| Cure Time | kg/cm | kg/cm | kg/cm | kg/cm | kg/cm | kg/cm |
| (hours) | (lbs/in) | (lbs/in) | (lbs/in) | (lbs/in) | (lbs/in) | (lbs/in) |
| 24 | 2.85 (15.9) | 7.61 (42.5) | 7.46 (41.7) | 11.42 (63.8) | 6.51 (36.4) | 5.35 (29.9) |
| 120 | 9.01 (50.4) | 8.73 (48.8) | 9.07 (50.7) | 9.59 (53.6) | 8.54 (47.7) | 9.27 (51.8) |
| 168 | 8.95 (50.0) | 8.63 (48.2) | 9.16 (51.2) | 8.34 (46.6) | 9.06 (50.6) | 8.79 (49.1) |
| 336 | 8.57 (47.9) | 8.04 (44.9) | 7.93 (44.3) | 7.07 (39.5) | 7.95 (44.4) | 8.59 (48.0) |
| Average | 100 | 100 | 100 | 100 | 100 | 100 |
| cohesive | | | | | | |
| failure, % | | | | | | |

Peel strength testing was performed for Examples 1 to 6 on bare aluminum immersed at 60° C. for 168 hours. Results are represented in Table 7.

TABLE 7
Peel Strength Testing - Aluminum Immersed at 60° C. for 168 Hours

| | Ex. 1 | Ex. 2 | Ex. 3 | Ex. 4 | Ex. 5 | Ex. 6 |
|---|---|---|---|---|---|---|
| | kg/cm | kg/cm | kg/cm | kg/cm | kg/cm | kg/cm |
| | (lbs/in) | (lbs/in) | (lbs/in) | (lbs/in) | (lbs/in) | (lbs/in) |
| AMS2629E | 3.74 (20.9) | 4.53 (25.3) | 5.14 (28.7) | 4.69 (26.2) | 5.10 (28.5) | 4.97 (27.8) |
| Fuel | | | | | | |
| AMS2629E | 52.5 | 90 | 95 | 100 | 100 | 100 |
| Fuel | | | | | | |
| (% cohesive | | | | | | |
| failure) | | | | | | |
| Salt Water | 6.44 (36.0) | 5.24 (29.3) | 6.57 (36.7) | 5.46 (30.5) | 6.17 (34.5) | 6.55 (36.6) |
| Salt Water | 75 | 100 | 100 | 100 | 100 | 100 |
| (% cohesive | | | | | | |
| failure) | | | | | | |

Peel strength testing was performed for Examples 1 to 6 on stainless steel with no immersion. Results are represented in Table 8.

TABLE 8
Peel Strength Testing - Stainless Steel with No Immersion

| | Ex. 1 | Ex. 2 | Ex. 3 | Ex. 4 | Ex. 5 | Ex. 6 |
|---|---|---|---|---|---|---|
| Cure Time | kg/cm | kg/cm | kg/cm | kg/cm | kg/cm | kg/cm |
| (hours) | (lbs/in) | (lbs/in) | (lbs/in) | (lbs/in) | (lbs/in) | (lbs/in) |
| 24 | 2.27 (12.7) | 4.22 (23.6) | 6.25 (34.9) | 10.95 (61.2) | 6.96 (38.9) | 6.51 (36.4) |
| 120 | 9.61 (53.7) | 9.56 (53.4) | 9.48 (53.0) | 10.43 (58.3) | 9.27 (51.8) | 10.47 (58.5) |
| 168 | 8.75 (48.9) | 8.73 (48.8) | 9.45 (52.8) | 9.59 (53.6) | 8.72 (48.7) | 9.38 (52.4) |
| 336 | 7.87 (44.0) | 8.54 (47.7) | 8.14 (45.5) | 8.27 (46.2) | 7.70 (43.0) | 8.48 (47.4) |
| Average | 100 | 100 | 100 | 100 | 100 | 100 |
| cohesive | | | | | | |
| failure, % | | | | | | |

Peel strength testing was performed for Examples 1 to 6 on stainless steel immersed at 60° C. for 168 hours. Results are represented in Table 9.

TABLE 9
Peel Strength Testing - Stainless Steel Immersed at 60° C. for 168 Hours

| | Ex. 1 | Ex. 2 | Ex. 3 | Ex. 4 | Ex. 5 | Ex. 6 |
|---|---|---|---|---|---|---|
| | kg/cm | kg/cm | kg/cm | kg/cm | kg/cm | kg/cm |
| | (lbs/in) | (lbs/in) | (lbs/in) | (lbs/in) | (lbs/in) | (lbs/in) |
| AMS2629E | 3.40 (19.0) | 5.04 (28.8) | 5.83 (32.6) | 4.83 (27.0) | 5.15 (28.8) | 5.10 (28.5) |
| Fuel | | | | | | |
| AMS2629E | 50 | 97.5 | 97.5 | 97.5 | 100 | 100 |
| Fuel | | | | | | |
| (% cohesive | | | | | | |
| failure) | | | | | | |
| Salt Water | 5.85 (32.7) | 6.51 (36.4) | 7.36 (41.1) | 5.83 (32.6) | 6.44 (36.0) | 6.37 (35.6) |
| Salt Water | 67.5 | 100 | 100 | 98.5 | 100 | 100 |
| (% cohesive | | | | | | |
| failure) | | | | | | |

Peel strength testing was performed for Examples 1 to 6 on aluminum coated with an epoxy primer conforming to AMS-C-27725 with no immersion. Results are represented in Table 10.

TABLE 10
Peel Strength Testing - Coated Aluminum with No Immersion

| | Ex. 1 | Ex. 2 | Ex. 3 | Ex. 4 | Ex. 5 | Ex. 6 |
|---|---|---|---|---|---|---|
| Cure Time | kg/cm | kg/cm | kg/cm | kg/cm | kg/cm | kg/cm |
| (hours) | (lbs/in) | (lbs/in) | (lbs/in) | (lbs/in) | (lbs/in) | (lbs/in) |
| 24 | 1.95 (10.9) | 1.88 (10.5) | 5.74 (32.1) | 7.28 (40.7) | 5.23 (29.2) | 5.74 (32.1) |
| 120 | 8.48 (47.4) | 10.58 (59.1) | 10.13 (56.6) | 8.88 (49.6) | 10.40 (58.1) | 9.82 (54.9) |
| 168 | 8.00 (44.7) | 8.38 (46.8) | 9.36 (52.3) | 8.82 (49.3) | 9.40 (52.5) | 9.04 (50.5) |
| 336 | 7.37 (41.2) | 7.78 (43.5) | 8.36 (46.7) | 7.63 (42.6) | 8.77 (49.0) | 8.04 (44.9) |
| Average | 100 | 100 | 100 | 100 | 100 | 100 |
| cohesive | | | | | | |
| failure, % | | | | | | |

Peel strength testing was performed for Examples 1 to 6 on aluminum coated with an epoxy primer conforming to AMS-C-27725 immersed at 60° C. for 168 hours. Results are represented in Table 11.

TABLE 11
Peel Strength Testing - Coated Aluminum Immersed at 60° C. for 168 hours

| | Ex. 1 | Ex. 2 | Ex. 3 | Ex. 4 | Ex. 5 | Ex. 6 |
|---|---|---|---|---|---|---|
| | kg/cm | kg/cm | kg/cm | kg/cm | kg/cm | kg/cm |
| | (lbs/in) | (lbs/in) | (lbs/in) | (lbs/in) | (lbs/in) | (lbs/in) |
| AMS2629E | 4.89 (27.3) | 5.40 (30.2) | 5.83 (32.6) | 5.01 (28.0) | 5.71 (31.9) | 5.35 (29.9) |
| Fuel | | | | | | |
| AMS2629E | 70 | 95 | 87.5 | 95 | 100 | 100 |
| Fuel | | | | | | |
| (% cohesive | | | | | | |
| failure) | | | | | | |
| Salt Water | 6.35 (35.5) | 6.64 (37.1) | 6.57 (36.7) | 6.41 (35.8) | 6.50 (36.3) | 6.75 (37.7) |
| Salt Water | 97.5 | 100 | 97.5 | 100 | 100 | 100 |
| (% cohesive | | | | | | |
| failure) | | | | | | |

Various modifications and alterations of this disclosure may be made by those skilled the art without departing from the scope and spirit of the disclosure, and it should be understood that this invention is not to be unduly limited to the illustrative embodiments set forth herein.

1. A composition comprising:
a first amino-functional silane comprising an amino group and a silane group, wherein the amino group and the silane group are connected by an organic linking group;
a second amino-functional silane comprising a secondary or tertiary amino group and least two independently selected silane groups, wherein the secondary or tertiary amino group is connected to each of the two independently selected silane groups by organic linking groups; and
a photoluminescent compound exhibiting photoluminescence at an excitation wavelength above 400 nanometers.

2. The composition of claim 1, wherein first amino-functional silane is represented by formula:
(R³)₂N—[R¹—Z]ₙ—R¹—[Si(Y)ₚ(R²)₃₋ₚ]
wherein
each R¹ is independently arylene or alkylene optionally interrupted or terminated by arylene;
R² is alkyl, aryl, or alkylenyl interrupted or terminated by aryl;
each Z is independently —O— or —N(R³)—;
each R³ is independently hydrogen, alkyl, aryl, or arylalkylenyl;
each Y is independently hydroxyl, alkoxy, acetoxy, aryloxy, or halogen;
n is 0, 1, 2, or 3; and
p is 1, 2, or 3.

3. A composition comprising:
a polyamino-functional silane comprising at least two amino groups and a silane group, wherein at least one of the amino groups and the silane group are connected by an organic linking group; and
a second amino-functional silane comprising a secondary or tertiary amino group and least two independently selected silane groups, wherein the secondary or tertiary amino group is connected to each of the two independently selected silane groups by organic linking groups.

4. The composition of claim 3, wherein the polyamino-functional silane and the second amino-functional silane together make up at least 70 percent of silane compounds in the composition.

5. The composition of claim 3, wherein the polyamino-functional silane is represented by formula:
(R⁹)₂N—[R⁷—N(H)]ₘ—R⁷—Si(Y)ₚ(R⁸)₃₋ₚ]
wherein
each R⁷ is independently alkylene;
R⁸ is alkyl, aryl, or alkylenyl interrupted or terminated by aryl;
each R⁹ is independently hydrogen, alkyl, or arylalkylenyl;
each Y is independently hydroxyl, alkoxy, acetoxy, aryloxy, or halogen;
m is 1, 2, or 3; and
p is 1, 2, or 3.

6. The composition of claim 5, wherein each R⁹ is hydrogen.

7. The composition of claim 3, further comprising a photoluminescent compound.

8. The composition of claim 7, wherein the photoluminescent compound exhibits photo-luminescence at an excitation wavelength above 400 nanometers.

9. The composition of claim 3, wherein the second amino-functional silane is represented by formula:
(R⁶)₂N—[R⁴—Z′]ᵣ—R⁴—[Si(Y)ₚ(R⁵)₃₋ₚ]
wherein
R⁴ is arylene or alkylene optionally interrupted or terminated by arylene;
each Z′ is independently —O— or —NR⁶—;
R⁵ is alkyl, aryl, or alkylenyl interrupted or terminated by aryl;
each R⁶ is independently hydrogen, alkyl, aryl, arylalkylenyl, or —R⁴—[Si(Y)ₚ(R⁵)₃₋ₚ];
each Y is independently hydroxyl, alkoxy, acetoxy, aryloxy, or halogen;
r is 0, 1, 2, or 3; and
p is 1, 2, or 3;
with the proviso that at least two independently selected —Si(Y)ₚ(R⁵)₃₋ₚ groups are present.

10. The composition of claim 9, wherein each R⁴ is independently alkylene, and r is 1, 2, or 3.

11. The composition of claim 3, wherein the polyamino-functional silane is [3-(2-aminoethylamino)propyl]trimethoxysilane, 3-[2-(2-aminoethylamino)ethylamino]propyltrimethoxysilane, or a combination thereof, and wherein the second amino-functional silane is N,N′-bis[3-trimethoxysilylpropyl]-ethylenediamine, N,N-bis[3-trimethoxysilylpropyl]-ethylenediamine, or a combination thereof.

12. The composition of claim 3, further comprising at least one of organic solvent or water.

13. (canceled)

14. A method of applying a sealant to a substrate, the method comprising:
applying the composition of claim 3 to a surface of the substrate to provide a primed surface; and
subsequently applying a curable sealant composition on the primed surface, the curable sealant composition comprising a polythiol.

15. The method of claim 14, further comprising inspecting the primed surface by exposing the primed surface to blue light before applying the curable sealant composition.

16. The method of claim 14, wherein the substrate comprises an aircraft component.

17. The composition of claim 1, wherein the second amino-functional silane is represented by formula:
(R⁶)₂N—[R⁴—Z′]ᵣ—R⁴—[Si(Y)ₚ(R⁵)₃₋ₚ];
wherein
R⁴ is arylene or alkylene optionally interrupted or terminated by arylene;
each Z′ is independently —O— or —NR⁶—;
R⁵ is alkyl, aryl, or alkylenyl interrupted or terminated by aryl;
each R⁶ is independently hydrogen, alkyl, aryl, arylalkylenyl, or —R⁴—[Si(Y)ₚ(R⁵)₃₋ₚ];
each Y is independently hydroxyl, alkoxy, acetoxy, aryloxy, or halogen;
r is 0, 1, 2, or 3; and
p is 1, 2, or 3;
with the proviso that at least two independently selected —Si(Y)ₚ(R⁵)₃₋ₚ groups are present.

18. The composition of claim 17, wherein each R⁴ is independently alkylene, and r is 1, 2, or 3.

19. The composition of claim 1, wherein the first amino-functional silane is [3-(2-aminoethylamino)propyl]trimethoxysilane, 3-(2-(2-aminoethylamino)ethylaminolpropyltrimethoxysilane, or a combination thereof, and wherein the second amino-functional silane is N,N′-bis[3-trimethoxysilylpropyl]-ethylenediamine, N,N-bis[3-trimethoxysilylpropyl]-ethylenediamine, or a combination thereof.

20. The composition of claim 1, further comprising at least one of organic solvent or water.

21. The composition of claim 1, wherein the first amino-functional silane and the second amino-functional silane together make up at least 70 percent of silane compounds in the composition.
